(19) United States
(12) Patent Application Publication
(10) Pub. No.: US 2010/0151231 A1
(43) Pub. Date: Jun. 17, 2010

(54) BONDED BODY AND BONDING METHOD

(75) Inventors: Yasuhide Matsuo, Nagano (JP); Kenji Otsuka, Nagano (JP); Kazuo Higuchi, Nagano (JP); Kosuke Wakamatsu, Nagano (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/668,094

(22) PCT Filed: Jul. 2, 2008
(86) PCT No.: PCT/JP2008/062007

§ 371 Date: Jan. 7, 2010

(30) Foreign Application Priority Data
Jul. 11, 2007 (JP) 2007-182677
May 21, 2008 (JP) 2008-133671

(51) Int. Cl. B32B 9/04; B32B 27/28; B29C 65/14; B32B 15/04

(52) U.S. Cl. 428/336; 428/447; 156/182

(57) ABSTRACT

A bonded body according to the present invention comprises a first object comprised of a first substrate and a first bonding film formed on the first substrate and a second object comprised of a second substrate and a second bonding film formed on the second substrate. The first and second bonding films contain a Si-skeleton constituted of constituent atoms containing silicon atoms and elimination groups bonded to the silicon atoms of the Si-skeleton. The Si-skeleton includes siloxane (Si—O) bonds. The constituent atoms are bonded to each other. When an energy is applied to at least a part region of the surface of each of the first and second bonding films, the elimination groups existing in the vicinity of the surface within the region are removed from the silicon atoms of the Si-skeleton so that each region develops a bonding property with respect to the other film to thereby bond the first and second objects together through the first and second bonding films.

### CROSS-REFERENCE TO RELATED APPLICATION

This application claims a priority to Japanese Patent Application No. 2007-182677 filed on Jul. 11, 2007 and Japanese Patent Application No. 2008-133671 filed on May 21, 2008 which are hereby expressly incorporated by reference herein in their entireties.

### BACKGROUND

1. Technical Field

The present invention relates to a bonded body and a bonding method.

2. Related Art

Conventionally, in the case where two members (base members) are bonded together, an adhesive such as an epoxy-based adhesive, an urethane-based adhesive, or a silicone-based adhesive has been often used.

In general, an adhesive exhibits reliably high adhesiveness regardless of constituent materials of the members to be bonded. Therefore, members formed of various materials can be bonded together in various combinations.

For example, a droplet ejection head (an ink-jet type recording head) included in an ink-jet printer is assembled by bonding, using an adhesive, several members formed of different kinds of materials such as a resin-based material, a metal-based material, and a silicon-based material.

When the members are to be bonded together using the adhesive to obtain an assembled body composed from the members, a liquid or paste adhesive is applied to surfaces of the members, and then the members are attached to each other via the applied adhesive on the surfaces thereof and firmly fixed together by hardening (setting) the adhesive with an action of heat or light.

However, in such an adhesive, there are problems in that bonding strength between the members is low, dimensional accuracy of the obtained assembled body is low, and it takes a relatively long time until the adhesive is hardened.

Further, it is often necessary to treat the surfaces of the members to be bonded using a primer in order to improve the bonding strength between the members. Therefore, additional cost and labor hour are required for performing the primer treatment, which causes an increase in cost and complexity of the process for bonding the members.

On the other hand, as a method of bonding members without using the adhesive, there is known a solid bonding method. The solid bonding method is a method of directly bonding members without an intervention of an intermediate layer composed of an adhesive or the like (see, for example, the following Patent Document).

Since such a solid bonding method does not need to use the intermediate layer composed of the adhesive or the like for bonding the members, it is possible to obtain a bonded body of the members having high dimensional accuracy.

However, in the case where the members are bonded together by using the solid bonding method, there are problems in that constituent materials of the members to be bonded are limited to specific kinds, a heat treatment having a high temperature (e.g., about 700 to 800° C.) must be carried out in a bonding process, and an atmosphere in the bonding process is limited to a reduced atmosphere.

In view of such problems, there is a demand for a method which is capable of firmly bonding members with high dimensional accuracy and efficiently bonding them at a low temperature regardless of constituent materials of the members to be bonded.

The patent document is JP A-5-82404 as an example of related art.

### SUMMARY

Accordingly, it is an object of the present invention to provide a bonded body formed by firmly bonding two base members together with high dimensional accuracy and efficiently bonding them together at a low temperature and therefore being capable of providing high reliability.

Further, it is another object of the present invention to provide a bonding method which is capable of efficiently bonding the two base members together at a low temperature.

A first aspect of the present invention is directed to a bonded body. The bonded body comprises a first object comprised of a first substrate and a first bonding film formed on the first substrate, and a second object comprised of a second substrate and a second bonding film formed on the second substrate.

The first bonding film contains a Si-skeleton constituted of constituent atoms containing silicon atoms and elimination groups bonded to the silicon atoms of the Si-skeleton. The Si-skeleton includes siloxane (Si—O) bonds. The constituent atoms are bonded to each other. The first bonding film has a surface.

The second bonding film has a surface. The second bonding film contains the Si-skeleton and the elimination groups which are the same as those contained in the first bonding film.

When an energy is applied to at least a part region of the surface of each of the first and second bonding films, the elimination groups existing in the vicinity of the surface within the region are removed from the silicon atoms of the Si-skeleton so that each region develops a bonding property with respect to the other film to thereby bond the first and second objects together through the first and second bonding films.

According to such an invention, it is possible to obtain a bonded body formed by firmly bonding two base members (first and second objects) together with high dimensional accuracy and efficiently bonding them together at a low temperature.

In the above bonded body, it is preferred that the constituent atoms have hydrogen atoms and oxygen atoms, and a sum of a content of the silicon atoms and a content of the oxygen atoms in the constituent atoms other than the hydrogen atoms is in the range of 10 to 90 atom % in at least one of the first and second bonding films.

According to such a bonded body, the first and second bonding films make it possible to form a firm network by the silicon atoms and the oxygen atoms, so that each of first and second bonding films becomes hard in itself. Therefore, the first and second bonding films make it possible to have high bonding strength with respect to the other film and the first and second substrates, respectively.

In the above bonded body; it is also preferred that the constituent atoms have oxygen atoms, and an abundance ratio of the silicon atoms and the oxygen atoms is in the range of 3:7 to 7:3 in the bonding film in at least one of the first and second bonding films.

This makes it possible for the first and second bonding films to have high stability, and thus it is possible to firmly bond the first and second bonding films together.

In the above bonded body, it is also preferred that a crystallinity degree of the Si-skeleton is equal to or lower than 45%.

This makes it possible for the constituent atoms of the Si-skeleton to bond to each other, and thus it is possible to obtain first and second bonding films exhibiting superior dimensional accuracy and bonding property.

In the above bonded body, it is also preferred that the Si-skeleton of at least one of the first and second bonding films contains Si—H bonds.

Since it is considered that the Si—H bonds prevent the siloxane bonds from being regularly produced, the siloxane bonds are formed so as to avoid the Si—H bonds. The constituent atoms constituting the Si-skeleton are bonded to each other in low regularity. That is, the constituent atoms are bonded. In this way, inclusion of the Si—H bonds in each of the first and second bonding films makes it possible to efficiently form the Si-skeleton having a low crystallinity degree.

in the above bonded body, it is also preferred that in the case where the at least one of the first and second bonding films containing the Si-skeleton containing the Si—H bonds is subjected to an infrared absorption measurement by an infrared adsorption measurement apparatus to obtain an infrared absorption spectrum having peaks, when an intensity of the peak derived from the siloxane bond in the infrared absorption spectrum is defined as “1”, an intensity of the peak derived from the Si—H bond in the infrared absorption spectrum is in the range of 0.001 to 0.2.

This makes it possible to obtain first and second bonding films each having a structure in which the constituent atoms are most bonded relatively. Therefore, it is possible to obtain the first and second bonding films having superior bonding strength, chemical resistance and dimensional accuracy.

In the above bonded body, it is also preferred that the elimination groups are constituted of at least one selected from the group consisting of a hydrogen atom, a boron atom, a carbon atom, a nitrogen atom, an oxygen atom, a phosphorus atom, a sulfur atom, a halogen-based atom and an atom group which is arranged so that these atoms are bonded to the Si-skeleton.

These elimination groups have relatively superior selectivity in bonding and eliminating to and from the silicon atoms of the constituent atoms of the Si-skeleton by applying energy thereto.

Therefore, the elimination groups can be eliminated from the silicon atoms relatively easily and uniformly by applying the energy thereto, which makes it possible to further increase bonding property of the first and second objects including the first and second bonding films, respectively.

In the above bonded body, it is also preferred that the elimination groups are an alkyl group containing a methyl group.

According to such a bonded body, the first and second bonding films each having the alkyl groups as the elimination groups can have excellent weather resistance and chemical resistance.

In the above bonded body, it is also preferred that in the case where the at least one of the first and second bonding films containing the methyl groups as the elimination groups is subjected to an infrared absorption measurement by an infrared absorption measurement apparatus to obtain an infrared absorption spectrum having peaks, when an intensity of the peak derived from the siloxane bond in the infrared absorption spectrum is defined as “1”, an intensity of the peak derived from the methyl group in the infrared absorption spectrum is in the range of 0.05 to 0.45.

This makes it possible to optimize a content of the methyl group as the elimination groups, thereby preventing the methyl group from end-capping the oxygen atoms of the siloxane bonds over a necessary degree. Therefore, since necessary and sufficient active hands exist in the first and second bonding films, sufficient bonding property is developed in the first and second bonding films. Further, the first and second bonding films can have sufficient weather resistance and chemical resistance which are derived from the methyl group.

In the above bonded body, it is also preferred that active hands are generated on the silicon atoms of the Si-skeleton contained in the at least one of the first and second bonding films, after the elimination groups existing at least in the vicinity thereof are removed from the silicon atoms of the Si-skeleton.

This makes it possible to obtain a bonded body that can be formed by firmly bonding the first and second bonding films together on the basis of chemical bonds.

In the above bonded body, it is also preferred that the active hands are dangling bonds or hydroxyl groups.

This makes it possible to especially firmly bond the first and second bonding films together.

In the above bonded body, it is also preferred that the at least one of the first and second bonding films is formed by using a plasma polymerization method.

This makes it possible to obtain a bonded body that can be formed by firmly bonding the first and second bonding films together. Further, the energy is applied to the first and second bonding films formed by using the plasma polymerization method, and then the elimination groups are removed from the silicon atoms. Such a state (activate state) is maintained for relatively a long period of time. Therefore, it is possible to simplify and streamline processes of a method of forming the bonded body.

In the above bonded body, it is also preferred that the at least one of the first and second bonding films is constituted of polyorganosiloxane as a main component thereof.

This makes it possible to obtain first and second bonding films having superior bonding property. Further, the first and second bonding films exhibit superior chemical resistance and weather resistance. Such first and second bonding films can be effectively used for the method of forming a bonded body which is exposed to chemicals for a long period of time.

In the above bonded body, it is also preferred that the polyorganosiloxane is constituted of a polymer of octamethyltrisiloxane as a main component thereof.

This makes it possible to obtain the first and second bonding films having superior bonding property.

In the above bonded body, it is also preferred that the plasma polymerization method includes a high frequency applying process and a plasma generation process, and a power density of the high frequency during the high frequency applying process and the plasma generation process is in the range of 0.01 to 100 W/cm².

This makes it possible to prevent excessive plasma energy from being applied to a raw gas due to too high output density of the high frequency. Further, it is also possible to reliably form the Si-skeleton in which the constituent atoms are bonded.

In the above bonded body, it is also preferred that an average thickness of the at least one of the first and second bonding films is in the range of 1 to 1000 nm.

This makes it possible to prevent dimensional accuracy of the bonded body obtained by bonding the first and second bonding films together from being significantly reduced, thereby enabling to more firmly bond them together.

In the above bonded body, it is also preferred that the at least one of the first and second bonding films is a solid-state film having no fluidity.

In this case, dimensional accuracy of the bonded body becomes extremely high as compared to a conventional bonded body obtained using an adhesive. Further, it is possible to firmly bond the first and second bonding films together in a short period of time as compared to the conventional bonded body.

In the above bonded body, it is also preferred that a refractive index of the at least one of the first and second bonding films is in the range of 1.35 to 1.6.

The refractive index of each of such first and second bonding films is relatively close to a refractive index of crystal or quarts glass. Therefore, such first and second bonding films are preferably used for manufacturing optical elements having a structure so as to pass through a bonding film.

In the above bonded body, it is also preferred that at least one of the first and second substrates has a plate shape.

In this case, the first and second substrates can easily bend. Therefore, the first and second substrates become sufficiently bendable according to shapes of the first and second substrates, respectively. This makes it possible to increase bonding strength between the first and second substrates through the first and second bonding films. Further, since the base member can easily bend, stress which would be generated in a bonding surface therebetween can be reduced to some extent.

In the above bonded body, it is also preferred that at least one of a portion of the first substrate on which the first bonding film is formed and a portion of the second substrate on which the second bonding film is formed are constituted of a silicon material, a metal material or a glass material as a main component thereof.

This makes it possible to increase bonding strengths of the first and second bonding films against the first and second substrates, respectively, even if the first and second substrates are not subjected to a surface treatment.

In the above bonded body, it is also preferred that the first substrates has a surface on which the first bonding film is provided, the second substrates has a surface on which the second bonding film is provided, and at least one of the surfaces of the first and second substrates has been, in advance, subjected to a surface treatment for improving bonding strength to at least one between the first substrate and the first bonding film and between the second substrate and the second bonding film.

By doing so, the surface of each of the first and second substrates can be cleaned and activated. This makes it possible to increase bonding strengths between the first substrate and the first bonding film and between the second substrate and the second bonding film.

In the above bonded body, it is also preferred that the surface treatment is a plasma treatment.

Use of the plasma treatment makes it possible to particularly optimize the surfaces of the first and second substrates so as to form the first and second bonding films thereon, respectively.

In the above bonded body, it is also preferred that the bonded body further comprises an intermediate layer provided in at least one between the first substrate and the first bonding film and between the second substrate and the second bonding film.

This makes it possible to obtain a bonded body having high reliability.

In the above bonded body, it is also preferred that the intermediate layer is constituted of an oxide-based material as a main component thereof.

This makes it possible to particularly increase bonding strength between the first and second substrates and the first and second bonding films, respectively.

A second aspect of the present invention is directed to a bonding method of forming a bonded body. The bonding method comprises: providing a first object comprised of a first substrate and a first bonding film formed on the first substrate, the first bonding film containing a Si-skeleton constituted of constituent atoms containing silicon atoms and elimination groups bonded to the silicon atoms of the Si-skeleton, the Si-skeleton including siloxane (Si—O) bonds, wherein the constituent atoms are bonded to each other, and the first bonding film having a surface; providing a second object comprised of a second substrate and a second bonding film formed on the second substrate, and the second bonding film having a surface, wherein the second bonding film contains the Si-skeleton and the elimination groups which are the same as those contained in the first bonding film; applying an energy to at least a part region of the surface of each of the first and second bonding films; and making the at least the part regions of the surfaces of the first and second bonding films close contact with each other, so that the first object and the second object are bonded together through the first and second bonding films, to thereby obtain the bonded body.

According to such a bonding method of the present invention, it is possible to efficiently bond the first and second objects together under a low temperature.

A third aspect of the present invention is directed to a bonding method of forming a bonded body. The bonding method comprises: providing a first object comprised of a first substrate and a first bonding film formed on the first substrate, the first bonding film containing a Si-skeleton constituted of constituent atoms containing silicon atoms and elimination groups bonded to the silicon atoms of the Si-skeleton, the Si-skeleton including siloxane (Si—O) bonds, wherein the constituent atoms are bonded to each other, and the first bonding film having a surface; providing a second object comprised of a second substrate and a second bonding film formed on the second substrate, and the second bonding film having a surface, wherein the second bonding film contains the Si-skeleton and the elimination groups which are the same as those contained in the first bonding film; making the surfaces of the first and second bonding films close contact with each other to thereby obtain a pre-contacted body; and applying an energy to at least a part region of the surface of each of the first and second bonding films in the pre-contacted body, so that the first object and the second object are bonded together through the first and second bonding films, to thereby obtain the bonded body.

According to such a bonding method of the present invention, it is possible to efficiently bond the first and second objects together under a low temperature. Further, in the state of the pre-contacted body, the first and second bonding films are not bonded together. This makes it possible to finely adjust a relative position of the first object with relative to the second object easily after they have been laminated together. As a result, it becomes possible to increase positional accuracy of the first object with relative to the second object in a direction of the surface of each of the first and second bonding films.

In the above bonding method, it is preferred that the applying the energy is carried out by at least one method selected from the group comprising a method in which an energy beam is irradiated on the first and second bonding films, a method in which the first and second bonding films are heated and a method in which a compressive force is applied to the first and second bonding films.

Use of this method makes it possible to relatively easily and efficiently apply the energy to the first and second bonding films.

In the above bonding method, it is also preferred that the energy beam is an ultraviolet ray having a wavelength of 150 to 300 nm.

Use of the ultraviolet ray having such a wavelength makes it possible to optimize an amount of the energy to be applied to the first and second bonding films. Therefore, it is possible to selectively cut bonds between the silicon atoms of the Si-skeleton and the elimination groups, while preventing the Si-skeletons contained in the first and second bonding films from being broken more than necessary.

As a result, it is possible to develop bonding property to the first and second bonding films, while preventing characteristics thereof such as mechanical characteristics or chemical characteristics from being reduced.

In the above bonding method, it is also preferred that a temperature of the heating is in the range of 25 to 100° C.

This makes it possible to reliably increase bonding strength between the first and second bonding films, while reliably preventing the bonded body from being thermally altered and deteriorated due to the heat.

In the above bonding method, it is also preferred that the compressive force is in the range of 0.2 to 10 MPa.

This makes it possible to reliably increase bonding strength between the first and second bonding films, while preventing occurrence of damages and the like in the first and second substrates or the first and second objects due to an excess pressure.

In the above bonding method, it is also preferred that the applying the energy is carried out in an atmosphere.

By doing so, it becomes unnecessary to spend labor hour and cost for controlling the atmosphere. This makes it possible to easily perform the application of the energy.

In the above bonding method, it is also preferred that the bonding method further comprises subjecting the bonded body to a treatment for improving bonding strength between the first and second bonding films.

This makes it possible to further increase the bonding strength between the first and second bonding films in the bonded body.

In the above bonding method, it is also preferred that the subjecting the bonded body to the treatment is carried out by at least one method selected from the group comprising a method in which an energy beam is irradiated on the bonded body, a method in which the bonded body is heated and a method in which a compressive force is applied to the bonded body.

This makes it possible to further increase the bonding strength between the first and second bonding films in the bonded body.

### BRIEF DESCRIPTION OF THE DRAWINGS

FIGS. 1A to 1C are longitudinal sectional views for explaining a first embodiment of a bonding method according to the present invention of bonding a substrate to an opposite substrate.

FIGS. 2E and 2F are longitudinal sectional views for explaining a first embodiment of a bonding method according to the present invention of bonding a substrate to an opposite substrate.

FIG. 3 is a partially enlarged view showing a state that before energy is applied to a bonding film in a bonded body according to the present invention.

FIG. 4 is a partially enlarged view showing a state that after energy is applied to a bonding film in a bonded body according to the present invention.

FIG. 5 is a vertical section view schematically showing a plasma polymerization apparatus used for a bonding method according to the present invention.

FIGS. 6A to 6C are longitudinal sectional views for explaining a method of forming a bonding film on a substrate.

FIGS. 7A to 7C are longitudinal sectional views for explaining a second embodiment of a bonding method according to the present invention of bonding a substrate to an opposite substrate.

FIGS. 8A to 8D are longitudinal sectional views for explaining a third embodiment of a bonding method according to the present invention of bonding a substrate to an opposite substrate.

FIGS. 9A to 9D are longitudinal sectional views for explaining a fourth embodiment of a bonding method according to the present invention of bonding a substrate to an opposite substrate.

FIG. 10 is an exploded perspective view showing an ink jet type recording head (a droplet ejection head) in which the bonded body according to the present invention is used.

FIG. 11 is a section view illustrating major parts of the ink jet type recording head shown in FIG. 10.

FIG. 12 is a schematic view showing one embodiment of an ink jet printer equipped with the ink jet type recording head shown in FIG. 10.

### DESCRIPTION OF EXEMPLARY EMBODIMENTS

Hereinafter, a bonded body, and a bonding method according to the present invention will be described in detail with reference to preferred embodiments shown in the accompanying drawings.

The bonded body of the present invention has two substrates (base members) 21 and 22, and two bonding films 31 and 32 provided between the two substrates 21 and 22, respectively. That is, the substrates 21 and 22 are bonded to each other through the two bonding films 31 and 32.

The bonding films 31 and 32 included in the bonded body contain an Si-skeleton having siloxane bonds (Si—O), of which constituent atoms are bonded to each other, and elimination groups bonding to silicon atoms of the Si-skeleton.

In each of such bonding films 31 and 32, when energy is applied to at least a part region of a surface of each of the bonding films 31 and 32 in a plan view thereof, that is, a whole region or a partial region of the surface of each of the bonding films 31 and 32 in the plan view thereof, the elimination groups, which exist in at least the vicinity of the surface within the region, are removed (left) from the silicon atoms of the Si-skeleton of the each of the bonding films 31 and 32.

This bonding films 31 and 32 have characteristics that the region of the surface, to which the energy has been applied, develops bonding property with respect to the other film due to the removal (eliminating) of the elimination groups.

According to the present invention, it is possible for the bonding films 31 and 32 having the characteristics described above to firmly bond to the two substrates 21 and 22 together with high dimensional accuracy and to efficiently bond the substrates 21 and 22 together at a low temperature.

In addition, by using such bonding films 31 and 32, it is possible to obtain a bonded body having high reliability, in which the substrate 21 and an opposite substrate 22 (two substrates) are firmly bonded to each other through the bonding films 31 and 32.

### First Embodiment

First, a description will be made on a first embodiment of each of the bonded body and a bonding method of the present invention.

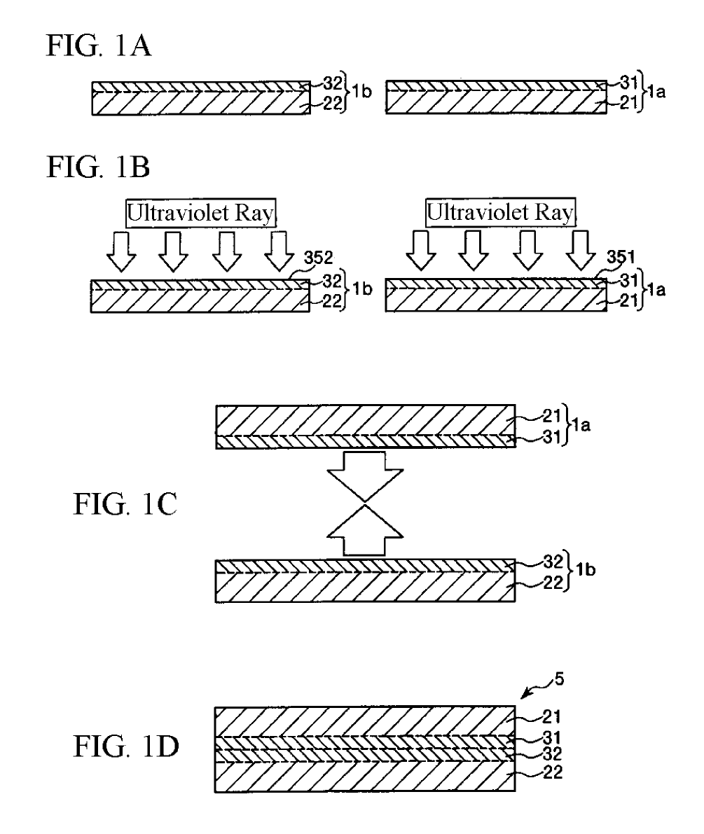

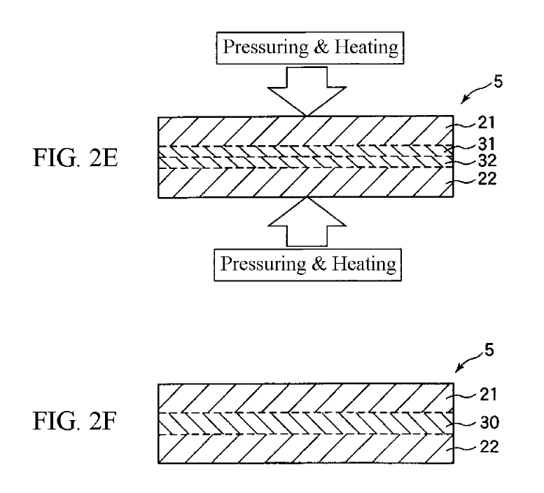

FIGS. 1A to 1D and 2E and 2F are longitudinal sectional views for explaining a first embodiment of a bonding method according to the present invention of bonding a substrate to an opposite substrate.

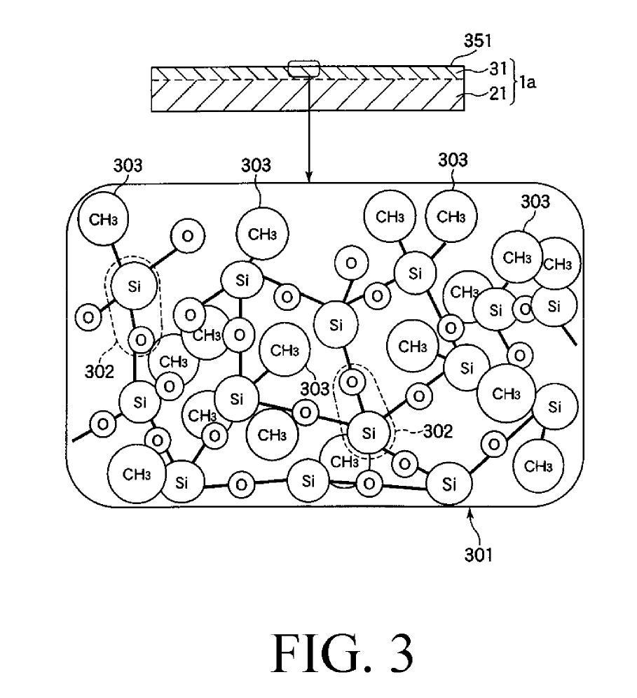

FIG. 3 is a partially enlarged view showing a state that before energy is applied to a bonding film in a bonded body according to the present invention.

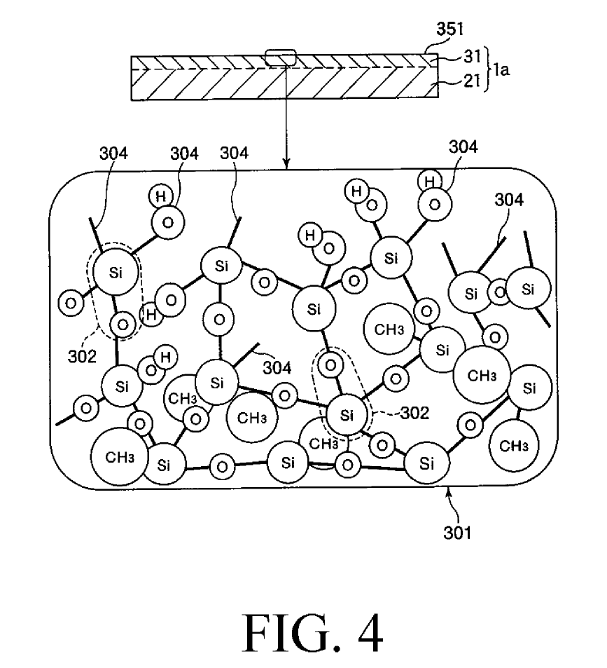

FIG. 4 is a partially enlarged view showing a state that after energy is applied to a bonding film in a bonded body according to the present invention.

In this regard, it is to be noted that in the following description, an upper side in each of FIGS. 1A to 1D, 2E and 2F, 3 and 4 will be referred to as “upper” and a lower side thereof will be referred to as “lower”.

The bonding method according to this embodiment includes a step of preparing (providing) a base member (first object) 1a including the bonding film 31 obtained by forming the bonding film 31 on one (upper) surface of the substrate 21, a step of applying energy to the bonding film 31 of the base member 1a so that it is activated by eliminating (removing) the elimination groups from the silicon atoms of the Si-skeleton, a step of preparing (providing) a base member (second object) 1b including the bonding film 32 (base member including another bonding film) obtained by forming the bonding film 32, which is the same as the bonding film 31, on one (upper) surface of the opposite substrate 22, and a step of making the bonding film 31 of the base member 1a and the bonding film 32 of the base member 1b close contact with each other so that they are bonded together through the bonding films 31 and 32, to thereby obtain a bonded body 5.

In this regard, it is to be noted that the base member 1a including the bonding film 31 is simply referred to as “base member 1a”. Likewise, it is to be noted that the base member 1b including the bonding film 32 is simply referred to as “base member 1b”.

Hereinafter, the respective steps of the bonding method according to this embodiment will be described one after another.

[1] First, the base member 1a is prepared.

As shown in FIG. 1A, the base member 1a includes the substrate (a base) 21 having a plate shape and the bonding film 31 provided on the substrate 21. The substrate 21 may be composed of any material, as long as it has such stiffness that can support the bonding film 31.

Especially, examples of a constituent material of the substrate 21 include: a resin-based material such as polyolefin (e.g., polyethylene, polypropylene, ethylene-propylene copolymer, ethylene-vinyl acetate copolymer (EVA)), cyclic polyolefin, denatured polyolefin, polyvinyl chloride, polyvinylidene chloride, polystyrene, polyamide, polyimide, polyamide-imide, polycarbonate, poly-(4-methylpentene-1), ionomer, acrylic resin, polymethyl methacrylate, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyester (e.g., polyethylene terephthalate (PET), polyethylene naphthalate, polybutylene terephthalate (PBT), polycyclohexane terephthalate (PCT)), polyether, polyether ketone (PEK), polyether ether ketone (PEEK), polyether imide, polyacetal (POM), polyphenylene oxide, denatured polyphenylene oxide, polysulfone, polyether sulfone, polyphenylene sulfide, polyarylate, liquid crystal polymer (e.g., aromatic polyester), fluoro resin (e.g., polytetrafluoroethylene, polyfluorovinylidene), thermoplastic elastomer (e.g., styrene-based elastomer, polyolefin-based elastomer, polyvinylchloride-based elastomer, polyurethane-based elastomer, polyester-based elastomer, polyamide-based elastomer, polybutadiene-based elastomer, trans-polyisoprene-based elastomer, fluororubber-based elastomer, chlorinated polyethylene-based elastomer), epoxy resin, phenolic resin, urea resin, melamine resin, aramid resin, unsaturated polyester, silicone resin, polyurethane, or a copolymer, a blended body and a polymer alloy each having at least one of these materials as a major component thereof; a metal-based material such as a metal (e.g., Fe, Ni, Co, Cr, Mn, Zn, Pt, Au, Ag, Cu, Pd, Al, W, Ti, V, Mo, Nb, Zr, Pr, Nd, Sm), an alloy containing at least one of these metals, carbon steel, stainless steel, indium tin oxide (ITO) or gallium arsenide; a semiconductor-based material such as Si, Ge, InP or GaPN; a silicon-based material such as monocrystalline silicon, polycrystalline silicon or amorphous silicon; a glass-based material such as silicic acid glass (quartz glass), silicic acid alkali glass, soda lime glass, potash lime glass, lead (alkaline) glass, barium glass or borosilicate glass; a ceramic-based material such as alumina, zirconia, ferrite, silicon nitride, aluminum nitride, boron nitride, titanium nitride, carbon silicon, boron carbide, titanium carbide or tungsten carbide; a carbon-based material such as graphite; a complex material containing any one kind of the above materials or two or more kinds of the above materials; and the like.

Further, a surface of the substrate 21 may be subjected to a plating treatment such as a Ni plating treatment, a passivation treatment such as a chromate treatment, a nitriding treatment, or the like.

Furthermore, a shape of the substrate (base) 21 is not particularly limited to a plate shape, as long as it has a shape with a surface which can support the bonding film 31. In other words, examples of the shape of the substrate 21 include a massive shape (blocky shape), a stick shape, and the like.

In this embodiment, since the substrate 21 has a plate shape, it can easily bend. Therefore, the substrate 21 becomes sufficiently bendable according to a shape of the opposite substrate 22. This makes it possible to increase bonding strength between such a substrate 21 and the opposite substrate 22 through the bonding films 31 and 32.

Further, it is also possible to increase bonding strength between the substrate 21 and the bonding film 31 in the base member 1a. In addition, since the substrate 21 can easily bend, stress which would be generated in a bonding surface therebetween can be reduced to some extent.

In this case, an average thickness of the substrate 21 is not particularly limited to a specific value, but is preferably in the range of about 0.01 to 10 mm, and more preferably in the range of about 0.1 to 3 mm. Further, it is preferred that the opposite substrate 22 also has an average thickness equal to that of the above substrate 21.

On the other hand, the bonding film 31 lies between the substrate 21 and the opposite substrate 22 described later, and can join them together.

As shown in FIGS. 3 and 4, the bonding film 31 contains an Si-skeleton 301 having siloxane bonds (Si—O) 302, of which constituent atoms are bonded to each other, and elimination groups 303 bonding to silicon atoms of the Si-skeleton 301.

The feature of the bonded body 5 of the present invention mainly resides on the characteristics of the bonding film 31 which is resulted from the structure thereof. In this regard, it is to be noted that the bonding film 31 will be described later in detail.

Prior to forming the bonding film 31, it is preferred that at least a predetermined region of the substrate 21 where the bonding film 31 is to be formed has been, in advance, subjected to a surface treatment for increasing bonding strength between the substrate 21 and the bonding film 31, depending on the constituent material of the substrate 21.

Examples of such a surface treatment include: a physical surface treatment such as a sputtering treatment or a blast treatment; a chemical surface treatment such as a plasma treatment performed using oxygen plasma and nitrogen plasma, a corona discharge treatment, an etching treatment, an electron beam irradiation treatment, an ultraviolet ray irradiation treatment or an ozone exposure treatment; a treatment performed by combining two or more kinds of these surface treatments; and the like.

By subjecting the predetermined region of the substrate 21 where the bonding film 31 is to be formed to such a treatment, it is possible to clean and activate the predetermined region. This makes it possible to increase the bonding strength between the bonding film 31 and the substrate 21.

Among these surface treatments, use of the plasma treatment makes it possible to particularly optimize the surface (the predetermined region) of the substrate 21 so as to be able to form the bonding film 31 thereon.

In this regard, it is to be noted that in the case where the surface of the substrate 21 to be subjected to the surface treatment is formed of a resin material (a polymeric material), the corona discharge treatment, the nitrogen plasma treatment and the like are particularly preferably used.

Depending on the constituent material of the substrate 21, the bonding strength of the bonding film 31 against the substrate 21 becomes sufficiently high even if the surface of the substrate 21 is not subjected to the surface treatment described above.

Examples of the constituent material of the substrate 21 with which such an effect is obtained include materials containing the various kinds of metal-based materials, the various kinds of silicon-based materials, the various kinds of glass-based materials and the like as a major component thereof.

The surface of the substrate 21 formed of such a material is covered with an oxide film. In the oxide film, hydroxyl groups having relatively high activity exist in a surface thereof. Therefore, in a case where the substrate 21 formed of such a material is used, it is possible to increase bonding strength of the bonding film 31 against the substrate 21 without subjecting the surface thereof to the surface treatment described above.

In this case, the entire of the substrate 21 may not be formed of the above materials, as long as at least the region of the surface of the substrate 21 where the bonding film 31 is to be formed is formed of the above materials.

Further, instead of the surface treatment, an intermediate layer have preferably been, in advance, provided on at least the predetermined region of the substrate 21 where the bonding film 31 is to be formed. This intermediate layer may have any function.

Such a function is not particularly limited to a specific kind. Examples of the function include: a function of increasing binding strength of the substrate 21 to the bonding film 31; a cushion property (that is, a buffering function); a function of reducing stress concentration and the like.

By using such a base member 1a in which the substrate 21 and the bonding film 31 are bonded to each other through the intermediate layer, a bonded body 5 having a high reliability can be obtained.

A constituent material of the intermediate layer include: a metal-based material such as aluminum or titanium; an oxide-based material such as metal oxide, or silicon oxide; a nitride-based material such as metal nitride or silicon nitride; a carbon-based material such as graphite or diamond-like carbon; a self-organization film material such as a silane coupling agent, a thiol-based compound, metal alkoxide or metal halide; a resin-based material such as a resin-based adhesive agent, a resin filming material, a resin coating material, various rubbers or various elastomer; and the like, and one or more of which may be used independently or in combination.

Among intermediate layers composed of these various materials, use of the intermediate layer composed of the oxide-based material makes it possible to further increase bonding strength between the substrate 21 and the bonding film 31 through the intermediate layer.

[2] Next, energy is applied to a surface 351 of the bonding film 31 of the base member 1a.

When the energy is applied to the surface 351 of the bonding film 31, the elimination groups 303 are removed from the silicon atoms of Si-skeleton 301 included in the bonding film 31. After the elimination groups 303 have been removed, active hands 304 are generated to the surface 351 and the inside of the bonding film 31.

As a result, the surface 351 of the bonding film 31 develops the bonding property with respect to the base member 1b, that is, the bonding film 31 is activated.

The base member 1a having such a state can be firmly bonded to the base member 1b on the basis of chemical bonds to be produced using the active hands 304.

The energy may be applied to the bonding film 31 by any method. Examples of the method include: a method in which an energy beam is irradiated on the bonding film 31; a method in which the bonding film 31 is heated; a method in which a compressive force (physical energy) is applied to the bonding film 31; a method in which the bonding film 31 is exposed to plasma (that is, plasma energy is applied to the bonding film 31); a method in which the bonding film 31 is exposed to an ozone gas (that is, chemical energy is applied to the bonding film 31); and the like.

Among these methods, in this embodiment, it is particularly preferred that the method in which the energy beam is irradiated on the bonding film 31 is used as the method in which the energy is applied to the bonding film 31. Since such a method can efficiently apply the energy to the bonding film 31 relatively easily, the method is suitably used as the method of applying the energy.

Examples of the energy beam include: a light such as an ultraviolet ray or a laser light; a particle beam such as a X ray, a y ray, an electron beam or an ion beam; and combinations of two or more kinds of these energy beams.

Among these energy beams, it is particularly preferred that the ultraviolet ray having a wavelength of about 150 to 300 nm is used (see FIG. 1B). Use of the ultraviolet ray having such a wavelength makes it possible to optimize an amount of the energy to be applied to the bonding film 31.

As a result, it is possible to selectively cut bonds between the elimination groups 303 and the silicon atoms of the Si-skeleton, while preventing the Si-skeleton included in the bonding film 31 from being broken more than necessary. This makes it possible for the bonding film 31 to develop the bonding property, while preventing characteristics thereof such as mechanical characteristics or chemical characteristics from being reduced.

Further, the use of the ultraviolet ray makes it possible to process a wide area of the surface 351 of the bonding film 31 without unevenness in a short period of time. Therefore, the removal (eliminating) of the elimination groups 303 can be efficiently performed.

Moreover, such an ultraviolet ray has, for example, an advantage that it can be generated by simple equipment such as an UV lamp. In this regard, it is to be noted that the wavelength of the ultraviolet ray is more preferably in the range of about 160 to 200 nm.

In the case where the UV lamp is used, power of the UV lamp is preferably in the range about of 1 mW/cm² to 1 W/cm², and more preferably in the range of about 5 to 50 mW/cm², although being different depending on an area of the surface 351 of the bonding film 31. In this case, a distance between the UV lamp and the bonding film 31 is preferably in the range of about 3 to 3000 mm, and more preferably in the range of about 10 to 1000 mm.

Further, a time for irradiating the ultraviolet ray is preferably set to an enough time for removing the elimination groups 303 from the vicinity of the surface 315 of the bonding film 31, i.e., an enough time not to remove a large number of the elimination groups 303 inside the bonding film 31.

Specifically, the time is preferably in the range of about 0.5 to 30 minutes, and more preferably in the range of about 1 to 10 minutes, although being slightly different depending on an amount of the ultraviolet ray, the constituent material of the bonding film 31, and the like. The ultraviolet ray may be irradiated temporally continuously or intermittently (in a pulse-like manner).

On the other hand, examples of the laser light include an excimer laser (femto-second laser), an Nd-YAG laser, an Ar laser, a CO₂ laser, a He—Ne laser, and the like.

Further, the irradiation of the energy beam on the bonding film 31 may be performed in any atmosphere. Specifically, examples of the atmosphere include: an oxidizing gas atmospheres such as atmosphere (air) or an oxygen gas; a reducing gas atmospheres such as a hydrogen gas; an inert gas atmospheres such as a nitrogen gas or an argon gas; a decompressed (vacuum) atmospheres obtained by decompressing these atmospheres; and the like.

Among these atmospheres, the irradiation is particularly preferably performed in the atmosphere. As a result, it becomes unnecessary to spend labor hour and cost for controlling the atmosphere. This makes it possible to easily perform (carry out) the irradiation of the energy beam.

In this way, according to the method of irradiating the energy beam, the energy can be easily applied to the vicinity of the surface 351 of the bonding film 31 selectively. Therefore, it is possible to prevent, for example, alteration and deterioration of the substrate 21 and the bonding film 31, i.e., alteration and deterioration of the base member 1a due to the application of the energy.

Further, according to the method of irradiating the energy beam, a degree (magnitude) of the energy to be applied can be accurately and easily controlled. Therefore, it is possible to adjust the number of the elimination groups 303 to be removed from the bonding film 31. By adjusting the number of the elimination groups 303 to be removed from the bonding film 31 in this way, it is possible to easily control bonding strength between the base member 1a and the base member 1b through the bonding films 31 and 32.

In other words, by increasing the number of the elimination groups 303 to be removed, since a large number of active hands 304 are generated in the vicinity of the surface 351 and the inside of the bonding film 31, it is possible to further increase the bonding property developed in the bonding film 31.

On the other hand, by reducing the number of the elimination groups 303 to be removed, it is possible to reduce the number of the active hands 304 generated in the vicinity of the surface 351 and the inside of the bonding film 31 and suppress the bonding property developed in the bonding film 31.

In order to adjust magnitude of the applied energy, for example, conditions such as the kind of the energy beam, the power of the energy beam, and the irradiation time of the energy beam only have to be controlled.

Moreover, according to the method of irradiating the energy beam, since large energy can be applied to the bonding film 31 in a short period of time, it is possible to more efficiently apply energy onto the bonding film 31.

As shown in FIG. 3, the bonding film 31 before the application of the energy has the Si-skeleton 301 and the elimination groups 303 in the vicinity of the surface 351 thereof. When the energy is applied to such a bonding film 31, the elimination groups 303 (methyl groups in FIG. 3) are removed from the silicon atoms of the Si-skeleton 301.

At this time, as shown in FIG. 4, the active hands 304 are generated on the surface 351 of the bonding film 31 to activate the surface 351 thereof. As a result, the bonding property is developed on the surface 351 of the bonding film 31.

Here, in this specification, a state that the bonding film 31 is “activated” means: a state that the elimination groups 303 existing on the surface 351 and in the inside of the bonding film 31 are removed as described above, and bonding hands (hereinafter, referred to as simply “non-bonding hands” or “dangling bonds”) not be end-capped are generated in the silicon atoms of Si-skeleton 301; a state that the non-bonding hands are end-capped by hydroxyl groups (OH groups); and a state that the dangling bonds and the hydroxyl groups coexist on the surface 351 of the bonding film 31.

Therefore, as shown in FIG. 4, the active hands 304 refer to the non-bonding hands (dangling bonds) and/or ones that the non-bonding hands are end-capped by the hydroxyl groups. If such active hands 304 exist on the surface 351 of the bonding film 31, it is possible to particularly firmly bond the base member 1a to the base member 1b through the bonding films 31 and 32.

In this regard, the latter state (that is, the state that the non-bonding hands are end-capped by the hydroxyl groups) is easily generated, because, for example, when the energy beam is merely irradiated on the bonding film 31 in an atmosphere, water molecules contained therein bond to the non-bonding hands.

In this embodiment, before the base member 1a and the base member 1b are laminated together, the energy has been applied to the bonding film 31 of the base member 1a in advance. However, such energy may be applied at a time when the base member 1a and the base member 1b are laminated together or after the base member 1a and the base member 1b have been laminated together. Such a case will be described in a second embodiment described below.

[3] The base member 1b is prepared. As shown in FIG. 1C, the base member 1a makes close contact with the base member 1b through the bonding films 31 and 32 thereof. As a result, the base member 1a is bonded to the base member 1b through the bonding films 31 and 32, to thereby obtain a bonded body 5 shown in FIG. 1D.

In the bonded body 5 obtained in this way, the base member 1a and the base member 1b are bonded together by firm chemical bonds formed in a short period of time such as a covalent bond, unlike bond (adhesion) mainly based on a physical bond such as an anchor effect by using the conventional adhesive. Therefore, it is possible to obtain a bonded body 5 in a short period of time, and to prevent occurrence of peeling, bonding unevenness and the like in the bonded body 5.

Further, according to such a method of manufacturing the bonded body 5 using the base member 1a, a heat treatment at a high temperature (e.g., a temperature equal to or higher than 700° C.) is unnecessary unlike the conventional solid bonding method. Therefore, the substrate 21 and the opposite substrate 22 each formed of a material having low heat resistance can also be used for bonding them.

In addition, the substrate 21 and the opposite substrate 22 are bonded together through the bonding films 31 and 32. Therefore, there is also an advantage that each of the constituent materials of the substrate 21 and the opposite substrate 22 is not limited to a specific kind.

For these reasons, according to the present invention, it is possible to expand selections of the constituent materials of the substrate 21 and the opposite substrate 22.

Moreover, in the conventional solid bonding method, the substrate 21 and the opposite substrate 22 are bonded together without intervention of a bonding layer. Therefore, in the case where the substrate 21 and the opposite substrate 22 exhibit a large difference in their thermal expansion coefficients, stress based on the difference tends to concentrate on a bonding interface therebetween. It is likely that peeling of the bonding interface and the like occur.

However, since the bonded body (the bonded body of the present invention) 5 has the bonding films 31 and 32, the concentration of the stress which would be generated is reduced due to the presence thereof. This makes it possible to accurately suppress or prevent occurrence of peeling in the bonded body 5.

Like the substrate 21, the opposite substrate 22 to be included in the base member 1b may be formed of any material. Specifically, the opposite substrate 22 can be formed of the same material as that constituting the substrate 21.

Further, like the substrate 21, a shape of the opposite substrate 22 is not particularly limited to a specific type, as long as it has a shape with a surface which can bond to the bonding film 32. Examples of the shape of the opposite substrate 22 include a plate shape (a film shape), a massive shape (a blocky shape), a stick shape, and the like.

The constituent material of the opposite substrate 22 may be different from or the same as that of the substrate 21.

Further, it is preferred that the substrate 21 and the opposite substrate 22 have substantially equal thermal expansion coefficients with each other.

In the case where the substrate 21 and the opposite substrate 22 have the substantially equal thermal expansion coefficients with each other, when the base member 1a and the base member 1b are bonded together, stress due to thermal expansion is less easily generated on a bonding interface therebetween. As a result, it is possible to reliably prevent occurrence of deficiencies such as peeling in the bonded body 5 finally obtained.

Further, in the case where the substrate 21 and the opposite substrate 22 have a difference in their thermal expansion coefficients with each other, it is preferred that conditions for bonding between the base member 1a and the base member 1b are optimized as follows. This makes it possible to firmly bond the base member 1a and the base member 1b together with high dimensional accuracy.

In other words, in the case where the substrate 21 and the opposite substrate 22 have the difference in their thermal expansion coefficients with each other, it is preferred that the base member 1a and the base member 1b are bonded together at as low temperature as possible. If they are bonded together at the low temperature, it is possible to further reduce thermal stress which would be generated on the bonding interface therebetween.

Specifically, the base member 1a and the base member 1b are bonded together in a state that each of the substrate 21 and the opposite substrate 22 is heated preferably at a temperature of about 25 to 50° C., and more preferably at a temperature of about 25 to 40° C., although being different depending on the difference between the thermal expansion coefficients thereof.

In such a temperature range, even if the difference between the thermal expansion coefficients of the substrate 21 and the opposite substrate 22 is rather large, it is possible to sufficiently reduce thermal stress which would be generated on the bonding interface between the base member 1a and the base member 1b. As a result, it is possible to reliably suppress or prevent occurrence of warp, peeling or the like in the bonded body 5.

Especially, in the case where the difference between the thermal expansion coefficients of the substrate 21 and the opposite substrate 22 is equal to or larger than 5×10⁻⁵/K, it is particularly recommended that the base member 1a and the base member 1b are bonded together at a low temperature as much as possible as described above. Moreover, it is preferred that the substrate 21 and the opposite substrate 22 have a difference in their rigidities. This makes it possible to more firmly bond the base member 1a and the base member 1b together.

Further, it is preferred that at least one substrate of the substrate 21 and the opposite substrate 22 is composed of a resin material. The substrate composed of the resin material can be easily deformed due to plasticity of the resin material itself.

Therefore, it is possible to reduce stress which would be generated on the bonding surface between the base members 1a and 1b (e.g., stress due to thermal expansion thereof). As a result, breaking of the bonding surface becomes hard. This makes it possible to obtain a bonded body 5 having high bonding strength between the base member 1a and the base member 1b.

As a case of the substrate 21, it is preferred that a predetermined region of the above mentioned opposite substrate 22 to which the bonding film 32 is to be bonded has been, in advance, subjected to the same surface treatment as employed in the substrate 21.

Further, depending on the constituent material of the opposite substrate 22, the bonding strength between the bonding film 32 and the opposite substrate 22 becomes sufficiently high even if the surface of the opposite substrate 22 is not subjected to the surface treatment described above.

Examples of the constituent material of the opposite substrate 22 with which such an effect is obtained include the same material as that constituting the substrate 21, that is, the various kinds of metal-based materials, the various kinds of silicon-based materials, the various kinds of glass-based materials and the like.

Here, a description will be made on a mechanism that the base member 1a and the base member 1b are bonded to each other in this process. It is conceived that this bonding results from one or both of the following mechanisms (i) and (ii).

Hereinafter, a description will be representatively offered regarding a case that hydroxyl groups are exposed on the surfaces 351 and 352 of the bonding films 31 and 32.

(i) When the two base members 1a and 1b are laminated together so that the bonding films 31 and 32 make close contact with each other, the hydroxyl groups existing on the surfaces 351 and 352 of the bonding films 31 and 32 thereof are attracted together, as a result of which hydrogen bonds are generated between the above adjacent hydroxyl groups. It is conceived that the generation of the hydrogen bonds makes it possible to bond the two base members 1a and 1b together.

Depending on conditions such as a temperature and the like, the hydroxyl groups bonded together through the hydrogen bonds are dehydrated and condensed, so that the hydroxyl groups and/or water molecules are removed from the bonding surface (the contact surface) between the two base members 1a and 1b. As a result, two atoms, to which the hydroxyl groups had been bonded, are bonded together directly or via an oxygen atom. In this way, it is conceived that the base members 1a and 1b are firmly bonded to each other.

(ii) When the two base members 1a and 1b are laminated together, the dangling bonds (non-bonding hands) not to be end-capped generated in the vicinity of the surfaces 351 and 352 and the inside of the bonding films 31 and 32 are bonded together. This bonding occurs in a complicated fashion so that the dangling bonds are inter-linked between the bonding films 31 and 32.

As a result, network-like bonds are formed in the bonding interface between the base members 1a and 1b. This ensures that either the silicon atoms or the oxygen atoms of the Si-skeletons 301 constituting the bonding films 31 and 32 are directly bonded together, as a result of which respective bonding films 31 and 32 are united (bonded) together.

By the above mechanism (i) and/or mechanism (ii), it is possible to obtain the bonded body 5a as shown in FIG. 1D.

In this regard, an activated state that the surfaces 351 and 352 of the bonding films 31 and 32 are activated in the step [2] is reduced with time. Therefore, it is preferred that this step [3] is started as early as possible after the step [2]. Specifically, this step [3] is preferably started within 60 minutes, and more preferably started within 5 minutes after the step [2].

If the step [3] is started within such a time, since the surfaces 351 and 352 of the bonding films 31 and 32 maintain a sufficient activated state, when the base member 1a is bonded to the base member 1b, they can be bonded together with sufficient high bonding strength therebetween.

In other words, each of the bonding films 31 and 32 before being activated is a film containing the Si-skeleton 301, and therefore it has relatively high chemical stability and excellent weather resistance. For this reason, the bonding films 31 and 32 before being activated can be stably stored for a long period of time. Therefore, the base member 1a having such a bonding film 31 may be used as follows.

Namely, first, a large number of the base members 1a have been manufactured or purchased, and stored in advance. Then just before the base member 1a makes close contact with the base member 1b in this step, the energy is applied to only a necessary number of the base members 1a as described in the step [2]. This use is preferable because the bonded bodies 5 are manufactured effectively.

In the manner described above, it is possible to obtain a bonded body (the bonded body of the present invention) 5 shown in FIG. 1D.

In FIG. 1D, the base member 1b is bonded (attached) to the base member 1a so as to cover the entire surface 351 of the bonding film 31 thereof. However, a relative position of the base member 1a with respect to the base member 1b may be shifted. In other words, the base member 1b may be bonded to the base member 1a so as to extend beyond the bonding film 31 thereof.

In the bonded body 5 obtained in this way, bonding strength between the substrate 21 and the opposite substrate 22 (the base members 1a and 1b) is preferably equal to or larger than 5 MPa (50 kgf/cm²), and more preferably equal to or larger than 10 MPa (100 kgf/cm²). Therefore, peeling of the bonded body 5 having such bonding strength therebetween can be sufficiently prevented.

As described later, in the case where a droplet ejection head is formed using the bonded body 5, it is possible to obtain a droplet ejection head having excellent durability. Further, use of the base member 1a of the present invention makes it possible to efficiently manufacture the bonded body 5 in which the substrate 21 and the opposite substrate 22 are bonded to each other through the bonding films 31 and 32 with the above large bonding strength therebetween.

In the conventional solid bonding method such as a bonding method of directly bonding silicon substrates, even if surfaces of the silicon substrates to be bonded together are activated, an activated state of each surface can be maintained only for an extremely short period of time (e.g., about several td several tens seconds) in an atmosphere. Therefore, there is a problem in that, after each surface is activated, for example, a time for bonding the two silicon substrates together cannot be sufficiently secured.

On the other hand, according to the present invention, since such a bonding method is performed by using the bonding film 31 having the Si-skeleton 301, the activated state of the bonding film 31 can be maintained over a relatively long period of time. Therefore, a time for bonding the base member 1a and the base member 1b together can be sufficiently secured, which makes it possible to improve efficiency of bonding them together.

Just when the bonded body 5 is obtained or after the bonded body 5 has been obtained, if necessary, at least one step (a step of increasing bonding strength between the base member 1a and the base member 1b) among three steps (steps [4A], [4B] and [4C]) described below may be applied to the bonded body 5. This makes it possible to further increase the bonding strength between the base member 1 and the base member 1b.

[4A] In this step, as shown in FIG. 2E, the obtained bonded body 5 is pressed in a direction in which the substrate 21 and the opposite substrate 22 come close to each other.

As a result, surfaces of the bonding films 31 and 32 come closer to the surface of the substrate 21 and the surface of the opposite substrate 22. It is possible to further increase the bonding strength between the members in the bonded body 5 (e.g., between the substrate 21 and the bonding film 31, between the bonding film 32 and the opposite substrate 22).

Further, by pressing the bonded body 5, spaces remaining in the boding interfaces (the contact interfaces) in the bonded body 5 can be crashed to further increase a bonding area (a contact area) thereof. This makes it possible to further increase the bonding strength between the members in the bonded body 5.

At this time, it is preferred that a pressure in pressing the bonded body 5 is as high as possible within a range in which the bonded body 5 is not damaged. This makes it possible to increase the bonding strength between the members in the bonded body 5 relative to a degree of this pressure.

In this regard, it is to be noted that this pressure can be appropriately adjusted, depending on the constituent materials and thicknesses of the substrate 21 and opposite substrate 22, conditions of a bonding apparatus, and the like.

Specifically, the pressure is preferably in the range of about 0.2 to 10 MPa, and more preferably in the range of about 1 to 5 MPa, although being slightly different depending on the constituent materials and thicknesses of the substrate 21 and opposite substrate 22, and the like.

By setting the pressure to the above range, it is possible to reliably increase the bonding strength between the members in the bonded body 5. Further, although the pressure may exceed the above upper limit value, there is a fear that damages and the like occur in the substrate 21 and the opposite substrate 22, depending on the constituent materials thereof.

A time for pressing the bonded body 5 is not particularly limited to a specific value, but is preferably in the range of about 10 seconds to 30 minutes. The pressing time can be appropriately changed, depending on the pressure for pressing the bonded body 5. Specifically, in the case where the pressure in pressing the bonded body 5 is higher, it is possible to increase the bonding strength between the members in the bonded body 5 even if the pressing time becomes short.

[4B] In this step, as shown in FIG. 2E, the obtained bonded body 5 is heated.

This makes it possible to further increase the bonding strength between the members in the bonded body 5. A temperature in heating the bonded body 5 is not particularly limited to a specific value, as long as the temperature is higher than room temperature and lower than a heat resistant temperature of the bonded body 5.

Specifically, the temperature is preferably in the range of about 25 to 200° C., and more preferably in the range of about 50 to 100° C. If the bonded body 5 is heated at the temperature of the above range, it is possible to reliably increase the bonding strength between the members in the bonded body 5 while reliably preventing them from being thermally altered and deteriorated.

Further, a heating time is not particularly limited to a specific value, but is preferably in the range of about 1 to 30 minutes.

In the case where both steps [4A] and [4B] are performed, the steps are preferably performed simultaneously. In other words, as shown in FIG. 2E, the bonded body 5 is preferably heated while being pressed. By doing so, an effect by pressing and an effect by heating are exhibited synergistically. This makes it possible to accelerate dehydration and condensation between the hydroxyl groups and bonding between the non-bonding hands in the interface (bonding surface) between the bonding films 31 and 32. As a result, it is possible to obtain a bonding film 30 which has been substantially absolutely integrated as shown in FIG. 2F.

[4C] In this step, an ultraviolet ray is irradiated on the obtained bonded body 5.

This makes it possible to increase the number of chemical bonds formed between the members in the bonded body 5 (e.g., between the substrate 21 and the bonding film 31, between the bonding films 31 and 32, and between the opposite substrate 22 and bonding film 32). As a result, it is possible to increase the bonding strength between the members in the bonded body 5, thereby increasing the bonding strength of the bonded body 5.

Conditions of the ultraviolet ray irradiated at this time can be the same as those of the ultraviolet ray irradiated in the step [2] described above.

Further, in the case where this step [4C] is performed, one of the substrate 21 and the opposite substrate 22 needs to have translucency. It is possible to reliably irradiate the ultraviolet ray on the bonding film 31 by irradiating it from the side of the substrate having translucency.

Through the steps described above, it is possible to further increase the bonding strength between the members in the bonded body 5 (especially, between the bonding film 31 and the substrate 21 and between the bonding films 31 and 32) with ease.

Here, as described above, the bonded body 5 of the present invention has characteristics in the structure of the bonding films 31 and 32. Hereinafter, since the bonding film 31 is the same as the bonding film 32, the bonding film 31 will be described as representative in detail.

As shown in FIGS. 3 and 4, the bonding film 31 contains the Si-skeleton 301 having the siloxane bonds (Si—O) 302, of which constituent atoms are bonded to each other, and the elimination groups 303 bonding to the silicon atoms of the Si-skeleton 301.

Such a bonding film 31 is a firm film which is difficult to be deformed due to the Si-skeleton 301 having the siloxane bonds (Si—O) 302, of which constituent atoms are bonded to each other.

It is considered that this is because it is difficult to generate defects such as dislocation and shift of the bonding film 31 in a crystal grain boundary due to the low crystallinity degree of the Si-skeleton 301. Therefore, the bonding strength, chemical resistance, and dimensional accuracy of the bonding film 31 in itself become high. As a result, in the finally obtained bonded body 5, the bonding strength, chemical resistance, and dimensional accuracy of the bonding body 5 also become high.

When the energy is applied to such a bonding film 31, the elimination groups 303 are removed from the silicon atoms of the Si-skeleton 301 to generate the active hands 304 in the vicinity of the surface 351 and the inside of the bonding film 31 as shown in FIG. 4. As a result, the surface 351 of the bonding film 31 develops the bonding property.

In the case where the bonding property is developed on the surface 351 of the bonding film 31, the base member 1a can be firmly and efficiently bonded to the base member 1b with high dimensional accuracy.

Furthermore, such a bonding film 31 is in the form of a solid having no fluidity. Therefore, thickness and shape of a bonding layer (the bonding film 31) are hardly changed as compared to a conventional adhesive layer formed of an aquiform or muciform (semisolid) adhesive having fluidity.

Therefore, the dimensional accuracy of the bonded body 5 obtained by bonding the base member 1a and the base member 1b together becomes extremely high as compared to a conventional bonded body obtained using the adhesive layer (the adhesive). In addition, since it is not necessary to wait until the adhesive is hardened, it is possible to firmly bond the base member 1a to the base member 1b in a short period of time as compared to the conventional bonded body.

A sum of a content of the silicon atoms and a content of oxygen atoms in the whole atoms (constituent atoms) constituting such a bonding film 31 other than the hydrogen atoms is preferably in the range of about 10 to 90 atom % and more preferably in the range of about 20 to 80 atom %.

Such a sum of the contents makes it possible to form a firm network bond between the silicon atoms and the oxygen atoms, thereby enabling to obtain the firm bonding film 31 in itself. Further, it is possible to obtain a bonding film 31 having high bonding strength with respect to the substrate 21 and the base member 1b.

An abundance ratio of the silicon atoms and the oxygen atoms contained in the bonding film 31 is preferably in the range of about 3:7 to 7:3 and more preferably in the range of about 4:6 to 6:4. By setting the abundance ratio of the silicon atoms and the oxygen atoms to a value within the above range, the bonding film 31 has high stability and can firmly bond the substrate 21 and the base member 1b.

The crystallinity degree of the Si-skeleton 301 included in the bonding film 31 is preferably equal to or lower than 45% as described above, and more preferably equal to or lower than 40%. This makes it possible to bond constituent atoms of the Si-skeleton 301. Therefore, characteristics of the Si-skeleton 301 described above are conspicuously exhibited, and therefore the bonding film 31 has superior dimensional accuracy and bonding property.

It is preferred that the bonding film 31 contains Si—H bonds in a chemical structure thereof. The Si—H bonds are formed in polymers obtained by polymerizing silane with a plasma polymerization method. At this time, it is considered that the Si—H bonds prevent siloxane bonds from being regularly formed.

Therefore, the siloxane bonds are formed so as to avoid the Si—H bonds, which reduce regularity of the constituent atoms of the Si-skeleton 301. According to such a plasma polymerization method, it is possible to efficiently form the Si-skeleton 301 having a low crystallinity degree.

The larger an amount of the Si—H bonds contained in the bonding film 31 is, the smaller the low crystallinity degree of the Si-skeleton 301 is not. The bonding film 31 is subjected to an infrared absorption measurement by an infrared absorption measurement apparatus to obtain an infrared absorption spectrum.

Then, when an intensity of a peak derived from a siloxane bond in the infrared absorption spectrum is defined as “1”, an intensity of a peak derived from a Si—H bond in the infrared absorption spectrum is preferably in the range of about 0.001 to 0.2, more preferably in the range of about 0.002 to 0.05 and even more preferably in the range of about 0.005 to 0.02.

By setting the intensity of the peak derived from the Si—H bond with respect to the intensity derived from the siloxane bond to a value within the above range, the constituent atoms of the Si-skeleton 301 included in the bonding film 31 are more bonded to each other in comparison.

If the intensity of the peak derived from the Si—H bond with respect to the intensity derived from the siloxane bond falls within the above range, the bonding film 31 has superior bonding strength, chemical resistance and dimensional accuracy.

As described above, the elimination groups 303 bonded to the silicon atoms contained in the Si-skeleton 301 are eliminated from the silicon atoms contained in the Si-skeleton 301 so that the active hands 304 are generated at portions of the Si-skeleton 301 where the elimination groups 303 have been existed.

In this way, the elimination groups 303 are relatively easily and uniformly eliminated from the silicon atoms thereof by applying energy to the bonding film 31. On the other hand, the elimination groups 303 are reliably bonded to the silicon atoms included in the Si-skeleton 301 so as not to be eliminated therefrom when no energy is applied to the bonding film 31.

From this viewpoint, the elimination groups 303 are preferably constituted of at least one selected from the group consisting of a hydrogen atom, a boron atom, a carbon atom, a nitrogen atom, an oxygen atom, a phosphorus atom, a sulfur atom, a halogen-based atom and an atom group in which these atoms are bonded to the constituent atoms of the Si-skeleton 301.

Such elimination groups 303 have relatively superior selectivity in bonding and eliminating to and from the silicon atoms by applying energy to the bonding film 31. Therefore, the elimination groups 303 satisfy the needs as described above so that the base member 1a has high bonding property.

Examples of the atom group in which the atoms described above are bonded to the constituent atoms of the Si-skeleton 301 include an alkyl group such as a methyl group and an ethyl group, an alkenyl group such as a vinyl group and an allyl group, an aldehyde group, a ketone group, a carboxyl group, an amino group, an amide group, a nitro group, a halogenated alkyl group, a mercapt group, a sulfone group, a cyano group, an isocyanate group and the like.

Among these groups mentioned above, the elimination groups 303 are preferably the alkyl group. Since the alkyl group has chemically high stability, the bonding film 31 containing the alkyl group as the elimination groups 303 exhibits superior weather resistance and chemical resistance.

In the case where the elimination groups 303 are the methyl group (—CH₃), an amount of the methyl group is obtained from an intensity of a peak derived from the methyl group in an infrared absorption spectrum which is obtained by subjecting the bonding film 31 to an infrared absorption measurement by an infrared absorption measurement apparatus as follows.

In the infrared absorption spectrum of the bonding film 31, when an intensity of a peak derived from a siloxane bond is defined as “1”, the intensity of the peak derived from the methyl group is preferably in the range of about 0.05 to 0.45, more preferably in the range of about 0.1 to 0.4 and even more preferably in the range of about 0.2 to 0.3. By setting the intensity of the peak derived from the methyl group with respect to the peak derived from the siloxane bond to a value within the above range, it is possible to appropriately form the siloxane bonds.

Further, since a necessary and sufficient number of the active hands 304 are formed in silicon atoms of the Si-skeleton 301 included in the bonding film 31, bonding property is developed in the bonding film 31. Furthermore, sufficient weather property and chemical property are given to the bonding film 31 due to bonding of the methyl group to the silicon atoms.

Examples of a constitute material of the bonding film 31 having such features include a polymer containing siloxane bonds such as polyorganosiloxane and the like. In the case where the bonding film 31 is constituted of polyorganosiloxane, the bonding film 31 has superior mechanical property in itself.

Further, the bonding film 31 also has superior bonding property to various materials. Therefore, the bonding film 31 constituted of polyorganosiloxane can firmly bond to the substrate 21 and the base member 1b, so that the substrate 21 can be firmly bonded to the opposite substrate 22 through the bonding films 31 and 32.

Polyorganosiloxane normally has repellency (non-bonding property). However, organic groups contained in polyorganosiloxane can be easily eliminated by applying energy to polyorganosiloxane, so that polyorganosiloxane has hydrophilic property and develops the bonding property. As a result, use of polyorganosiloxane makes it possible to easily and reliably control the non-bonding property and the bonding property.

In this regard, it is to be noted that the repellency (non-bonding property) is an effect due to alkyl groups contained in polyorganosiloxane. Therefore, the bonding film 31 constituted of polyorganosiloxane has the bonding property in regions of the surface 351 thereof to which energy is applied. In addition, it is possible to obtain actions and effects derived from the alkyl groups described above in parts other than the surface 351.

Therefore, the bonding film 31 exhibits superior weather resistance and chemical resistance. For example, in a case where substrates are bonded together so as to be exposed to chemicals for a long period of time, such a bonding film 31 can be effectively used.

As a result, when a head included in an industrial ink jet printer using an organic ink which easily corrades resin materials is produced, the head can have superior durability and high reliability by using the base member 1a which includes the bonding film 31 constituted of polyorganosiloxane.

Among polyorganosiloxane, the bonding film 31 is preferably constituted of a polymer of octamethyltrisiloxane as a main component thereof. The bonding film 31 constituted of the polymer of octamethyltrisiloxane as a main component thereof exhibits particularly superior bonding property. Therefore, such a bonding film 31 is preferably used in the bonded body 5 according to the present invention.

Further, octamethyltrisiloxane is a liquid form at a normal temperature and has appropriate viscosity. Therefore, octamethyltrisiloxane has an advantage in that it can be easily handled.

Further, an average thickness of the bonding film 31 is preferably in the range of about 1 to 1000 nm, and more preferably in the range of about 2 to 800 nm. By setting the average thickness of the bonding film 31 to the above range, it is possible to prevent dimensional accuracy of the bonded body 5 obtained by bonding the base member 1a and the base member 1b together from being significantly reduced, thereby enabling to firmly bond them together.

In other words, if the average thickness of the bonding film 31 is lower than the above lower limit value, there is a case that the bonded body 5 having sufficient bonding strength between the base member 1a and the base member 1b cannot be obtained. In contrast, if the average thickness of the bonding film 31 exceeds the above upper limit value, there is a fear that the dimensional accuracy of the bonded body 5 is reduced significantly.

In addition, in the case where the average thickness of the bonding film 31 is set to the above range, the bonding film 31 can have a certain degree of shape following property. Therefore, even if irregularities exist on a bonding surface (a surface to be adjoined to the bonding film 31) of the substrate 21, the bonding film 31 can be formed so as to assimilate the irregularities of the bonding surface of the substrate 21, though it may be affected depending on sizes (heights) thereof.

As a result, it is possible to suppress sizes of irregularities of the surface 351 of the bonding film 31, which would be generated according to the irregularities of the bonding surface of the substrate 21, from being extremely enlarged. Namely, it is possible to improve flatness of the surface 351 of the bonding film 31. This makes it possible to increase bonding strength between the bonding films 31 and 32 in bonding the base member 1a and the base member 1b together.

The thicker the thickness of bonding film 31 is, the higher degrees of the above flatness of the surface 351 and shape following property of the bonding film 31 become. Therefore, it is preferred that the thickness of the bonding film 31 is as thick as possible in order to further improve the degrees of the flatness of the surface 351 and the shape following property of the bonding film 31.

Such a bonding film 31 may be produced by any method. Examples of the method of producing the bonding film 3 include: various kinds of gas-phase film formation methods such as a plasma polymerization method, a CVD method, and a PVD method; various kinds of liquid-phase film formation methods; and the like. Among these methods mentioned above, the plasma polymerization method is preferable.

According to the plasma polymerization method, it is possible to efficiently produce a compact and homogenous bonding film 31. Therefore, the bonding film 31 produced by using the plasma polymerization method makes it possible to firmly be bonded to the base member 1b.

Further, the bonding film 31 produced by using the plasma polymerization method can maintain a state activated by applying energy thereto for a long period of time. Therefore, it is possible to simplify and streamline the producing process of the bonded body 5.

Hereinafter, a description will be made on a method of producing a bonding film 31 by using a plasma polymerization method.

First, prior to the description of the method of producing the bonding film 31, a description will be made on a plasma polymerization apparatus used for producing the bonding film 31 on the substrate 21 by using the plasma polymerization method.

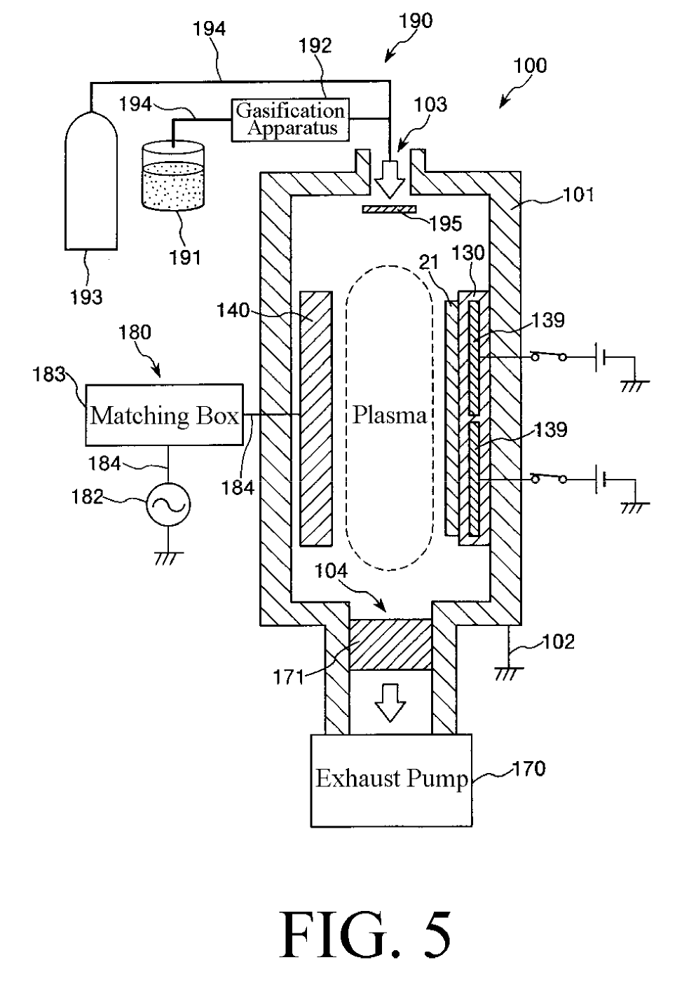

FIG. 5 is a vertical section view schematically showing a plasma polymerization apparatus used for a bonding method according to the present invention. In the following description, the upper side in FIG. 5 will be referred to as “upper” and the lower side thereof will be referred to as “lower” for convenience of explanation.

The plasma polymerization apparatus 100 shown in FIG. 5 includes a chamber 101, a first electrode 130 formed on an inner surface of the chamber 101, a second electrode 140 facing the first electrode 130, a power circuit 180 for applying a high-frequency voltage across the first electrode 130 and the second electrode 140, a gas supply part 190 for supplying a gas into the chamber 101, and a exhaust pump 170 for exhausting the gas supplied into the chamber 101 by the gas supply part 190.

Among these parts, the first electrode 130 and the second electrode 140 are provided in the chamber 101. Hereinafter, a description will be made on these parts in detail.

The chamber 101 is a vessel that can maintain air-tight condition of the inside thereof. Since the chamber 101 is used in a state of a reduced pressure (vacuum) of the inside thereof, the chamber 101 has pressure resistance property which is property that can withstand a pressure difference between the inside and the outside of the chamber 101.

The chamber 101 shown in FIG. 5 is composed from a chamber body of a substantially cylindrical shape, of which axial line is provided along a vertical direction. A supply opening 103 is provided in an upper side of the chamber 101. An exhaust opening 104 is provided in a lower side of the chamber 101.

A gas pipe 194 of the gas supply part 190 is connected to the supply opening 103. The exhaust pump 170 is connected to the exhaust opening 104.

In the present embodiment, the chamber 101 is constituted of a metal material having high conductive property and is electrically grounded through a grounding conductor 102.

The first electrode 130 has a plate shape and supports the substrate 21. In other words, the substrate 21 is provided on the surface of the first electrode 130. The first electrode 130 is provided on the inner surface of the chamber 101 along a vertical direction. In this way, the first electrode 130 is electrically grounded through the chamber 101 and the grounding conductor 102. In this regard, it is to be noted that the first electrode 130 is formed in a concentric manner as the chamber body as shown in FIG. 5.

An electrostatic chuck (attraction mechanism) 139 is provided in the first electrode 130. As shown in FIG. 5, the substrate 21 can be attracted by the electrostatic chuck 139 along the vertical direction. With this structure, even if some warpage have been formed to the substrate 21, the substrate 21 can be subjected to a plasma treatment in a state that the warpage is corrected by attracting the substrate 21 to the electrostatic chuck 139.

The second electrode 140 is provided in facing the first electrode 130 through the substrate 21. In this regard, it is to be noted that the second electrode 140 is provided in a spaced-apart relationship (a state of insulating) with the inner surface of the chamber 101.

A high-frequency power 182 is connected to the second electrode 140 through a wire 184 and a matching box 183. The matching box 183 is provided on the way of wire 184 which is provided between the second electrode 140 and the high-frequency power 182. The power circuit 180 is composed from the wire 184, the high-frequency power 182 and the matching box 183.

According to the power circuit 180, a high-frequency voltage is applied across the first electrode 130 and the second electrode 140 due to ground of the first electrode 130. Therefore, an electric field in which a movement direction of an electronic charge carrier is alternated in high frequency is formed between the first electrode 130 and the second electrode 140.

The gas supply part 190 supplies a predetermined gas into the chamber 101. The gas supply part 190 shown in FIG. 5 has a liquid reservoir part 191 for reserving a film material in a liquid form (raw liquid), a gasification apparatus 192 for changing the film material in the liquid form to the film material in a gas form, and a gas cylinder 193 for reserving a carrier gas.

The liquid reservoir part 191, the gasification apparatus 192, the gas cylinder 193 and the supply part 103 of the chamber 101 are connected with a wire 194. A mixture gas of the film material in the gas form and the carrier gas are supplied from the supply part 103 into the chamber 101.

The film material in the liquid form reserved in the liquid reservoir part 191 is a raw material that is polymerized by using the plasma polymerization apparatus 100 so that a plasma polymerization film is formed on the surface of the substrate 21. Such a film material in the liquid form is gasified by the gasification apparatus 192, thereby changing to the film material in the gas form (raw gas). Then, the film material in the gas form is supplied into the chamber 101. In this regard, the raw gas will be described later in detail.

The carrier gas reserved in the gas cylinder 193 is discharged in the electric field and supplied in the chamber 101 in order to maintain the discharge. Examples of such a carrier gas include Ar gas, He gas and the like.

A diffuser plate 195 is provided near the supply part 103 of the inside of the chamber 101. The diffuser plate 195 has a function of accelerating diffusion of the mixture gas supplied into the chamber 101. This makes it possible to uniformly diffuse the mixture gas in the chamber 101.

The exhaust pump 170 exhausts the mixture gas in the chamber 101 and is composed from a oil-sealed rotary pump, a turbo-molecular pump or the like. By exhausting an air and reducing pressure in the chamber 101, it is possible to easily change the mixture gas to plasma.

Further, it is also possible to prevent the substrate 21 from being contaminated or oxidized by contacting with the atmosphere. Furthermore, it is also possible to efficiently remove reaction products obtained by subjecting the substrate 21 to plasma polymerization apparatus 100 from the inside of the chamber 101.

A pressure control mechanism 171 for adjusting the pressure in the chamber 101 is provided in the exhaust opening 104. This makes it possible to appropriately set the pressure in the chamber 101 depending on a supply amount of the mixture gas.

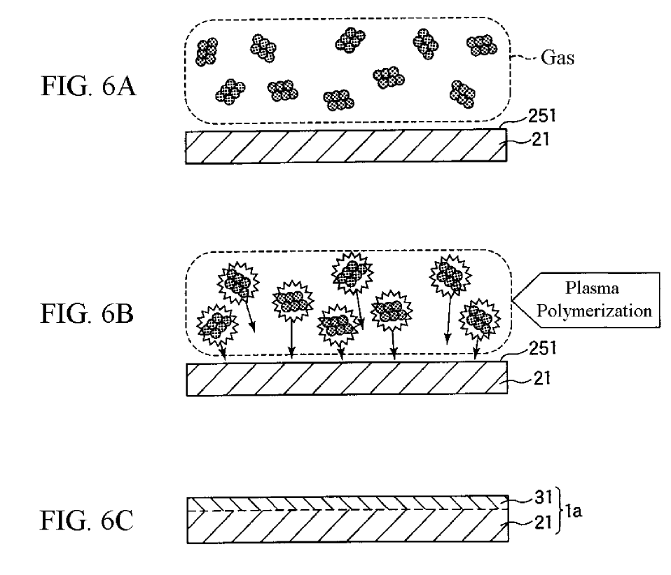

Next, a description will be made on the method of producing the bonding film 31 on the substrate 21 by using the plasma polymerization apparatus 100 described above. FIGS. 6A to 6C are longitudinal sectional views for explaining a method of forming a bonding film on a substrate. In the following description, the upper side in FIGS. 6A to 6C will be referred to as “upper” and the lower side thereof will be referred to as “lower” for convenience of explanation.

A mixture gas of a raw gas and a carrier gas is supplied into a strong electrical field to thereby polymerize molecules contained in the raw gas, so that a polymer is deposited on the substrate 21 to obtain the bonding film 31. Hereinafter, a description will be made on the concrete method.

First, the substrate 21 is prepared. Next, if needed, the surface (bonding surface) 251 of the substrate 21 is subjected to a surface treatment as described above.

Next, the substrate 21 is placed into the chamber 101 of the plasma polymerization apparatus 100. After the chamber is sealed, a pressure inside the chamber 101 is reduced by activating the exhaust pump 170.

Next, the mixture gas of the raw gas and the carrier gas is supplied into the chamber 101 by activating the gas supply part 190, thereby the chamber 101 is filled with the supplied mixture gas (FIG. 6A).

A ratio (mix ratio) of the raw gas in the mixture gas is preferably set in the range of about 20 to 70% and more preferably in the range of about 30 to 60%, though the ratio is slightly different depending on a kind of raw gas or carrier gas and an intended deposition speed. This makes it possible to optimize conditions for forming (depositing) the polymerization film (that is, the bonding film 31).

A flow rate of the supplying mixture gas, namely each of the raw gas and the carrier gas, is appropriately decided depending on a kind of raw gas or carrier gas, an intended deposition speed, a thickness of a film to be formed or the like. The flow rate is not particularly limited to a specific rate, but normally is preferably set in the range of about 1 to 100 ccm and more preferably in the range of about 10 to 60 ccm.

Next, a high-frequency voltage is applied across the first electrode 130 and the second electrode 140 by activating the power circuit 180. In this way, the molecules contained in the raw gas which exists between the first electrode 130 and the second electrode 140 are allowed to ionize, thereby generating plasma.

Then, the molecules contained in the raw gas are polymerized by plasma energy to obtain polymers, thereafter the obtained polymers are allowed to adhere to the surface 251 of the substrate 21 and are deposited thereon as shown in FIG. 6B. As a result, as shown in FIG. 6C, the bonding film 31 constituted of the plasma polymerization film is formed on the surface 251 of the substrate 21.

In this regard, the surface 251 of the substrate 21 is activated and cleared by the action of the plasma. Therefore, the polymers of the molecules contained in the raw gas are easily deposited on the surface 251 of the substrate 21. As a result, it is possible to reliably form a bonding film 31 stably. According to the plasma polymerization method, it is possible to obtain high bonding strength between the substrate 21 and the bonding film 31 despite of the constituent material of the substrate 21.

Examples of the raw gas to be contained in the mixture gas include organosiloxane such as methyl siloxane, octamethyl trisiloxane, decamethyl tetrasilixane, decamethyl cyclopentasiloxane, octamethyl cyclotetrasiloxarie, and methylphenylsiloxane and the like.

The plasma polymerization film obtained by using such a raw gas, namely the bonding film 31 (polymers) is obtained by polymerizing the raw materials thereof. That is to say, the bonding film 31 is constituted of polyorganosiloxane.

In the plasma polymerization, a frequency of the high-frequency voltage applied between the first electrode 130 and the second electrode 140 is not particularly limited to a specific value, but is preferably in the range of about 1 kHz to 100 MHz and more preferably in the range of about 10 to 60 MHz.

An output density of the high-frequency voltage is not particularly limited to a specific value, but is preferably in the range of about 0.01 to 100 W/cm², more preferably in the range of about 0.1 to 50 W/cm² and even more preferably in the range of about 1 to 40 W/cm².

By setting the output density of the high-frequency voltage to a value within the above range, it is possible to reliably form the Si-skeleton 301 of which constituent atoms are bonded to each other while preventing excessive plasma energy from being applied to the raw gas due to too high output density of the high-frequency voltage.

If the output density of the high-frequency voltage is smaller than the lower limit value noted above, the molecules contained in the raw gas can not be polymerized. Therefore, there is a possibility that the bonding film 31 can not be formed.

On the other hand, if the output density of the high-frequency voltage exceeds the upper limit value noted above, the molecules contained in the raw gas is decomposed and the elimination groups 303 are eliminated from the silicon atoms of Si-skeleton 301 of the molecules contained in the raw gas. As a result, there are possibilities that a content of the elimination group 303 contained in the Si-skeleton 301 constituting the bonding film 31 is greatly lowered and it is difficult to bond the constituent atoms of the Si-skeleton 301.

An inside pressure of the chamber 101 during the deposition is preferably in the range of about 133.3'10⁻⁵ to 1333 Pa (1×10⁻⁵ to 10 Torr) and more preferably in the range of about 133.3×10⁻⁴ to 133.3 Pa (1×10⁻⁴ to 1 Torr).

A flow rate of the raw gas is preferably in the range of about 0.5 to 200 sccm and more preferably in the range of about 1 to 100 sccm. A flow rate of the carrier gas is preferably in the range of about 5 to 750 sccm and more preferably in the range of about 10 to 500 sccm.

A time required for the deposition is preferably in the range of about 1 to 10 minutes and more preferably in the range of about 4 to 7 minutes. A temperature of the substrate 21 is preferably 25° C. or higher and more preferably in the range of about 25 to 100° C.

As described above, the bonding film 31 can be obtained, thereby obtaining the base member 1a. Furthermore, the base member 1b is obtained by the same method as that of the base member 1a.

In this regard, it is to be noted that light is transmissive in the bonding film 31. By appropriately setting formation conditions of the bonding film 31 (conditions of polymerizing using plasma, a composition of the raw gas, and the like), it is possible to adjust a refractive index of the bonding film 31.

Specifically, by improving the output density of the high-frequency voltage in the plasma polymerization method, it is possible to improve the refractive index of the bonding film 31. On the contrary, by reducing the output density of the high-frequency voltage in the plasma polymerization method, it is possible to reduce the refractive index of the bonding film 31.

According to the plasma polymerization method, the bonding film 31 having refractive index of the range of about 1.35 to 1.6 is obtained. Since such a refractive index of the bonding film 31 is close to a refractive index of each of crystal and a quartz glass, the bonding film 31 is preferably used when optical elements having a structure in which light passes through the bonding film 31 are produced.

Further, since the refractive index of the bonding film 31 can be adjusted, it is possible to produce a bonding film 31 having a predetermined refractive index.

### Second Embodiment

Next, a description will be made on a second embodiment of each of a bonded body and a bonding method of the present invention.

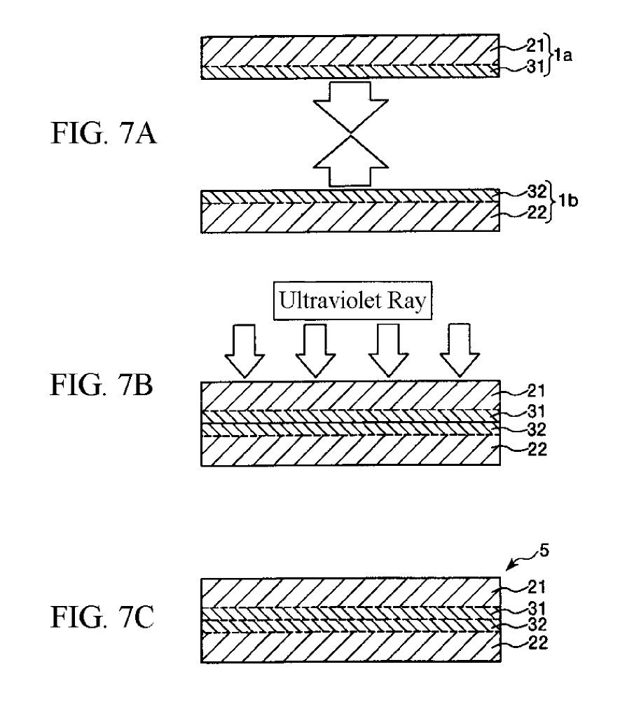

FIGS. 7A to 7C are longitudinal sectional views for explaining a second embodiment of a bonding method according to the present invention of bonding a substrate to an opposite substrate. In this regard, it is to be noted that in the following description, an upper side in each of FIGS. 7A to 7C will be referred to as “upper” and a lower side thereof will be referred to as “lower”.

Hereinafter, the bonding method according to the second embodiment will be described by placing emphasis on the points differing from the first embodiment, with the same matters omitted from description.

The bonding method according to this embodiment is the same as that of the first embodiment, except that after the base member 1a and the base member 1b are laminated together, the energy is applied to the bonding films 31 and 32.

In other words, the bonding method according to this embodiment includes a step of preparing (providing) the base member 1a and the base member 1b, a step of laminating the prepared the base member 1b and the base member 1a together so as to make the bonding films 31 and 32 close contact with each other to obtain a pre-contacted body in which they have been laminated together, and a step of applying the energy to the bonding films 31 and 32 in the pre-contacted body so that they are activated and the base member 1a and the base member 1b are bonded together between the bonding films 31 and 32, to thereby obtain a bonded body 5.

Hereinafter, the respective steps of the bonding method according to this embodiment will be described one after another.

[1] First, the base member 1a is prepared in the same manner as in the first embodiment (see FIG. 7A).

[2] Next, as shown in FIG. 7B, the base member 1b is prepared. Thereafter, the base member 1a and the base member 1b are laminated together so that the surface 351 of the bonding film 31 thereof and the surface 352 of the bonding film 32 thereof make close contact with each other, to obtain the pre-contacted body.

In the state of the pre-contacted body, the base member 1a and the base member 1b are not bonded together. Therefore, it is possible to adjust a relative position of the base member 1a with respect to the base member 1b.

This makes it possible to finely adjust the relative position of the base member 1a with relative to the base member 1b easily by shifting them after they have been laminated (overlapped) together. As a result, it becomes possible to increase positional accuracy of the base member 1a with relative to the base member 1b in a direction of the surface 351 of the bonding film 31.

[3] Then, as shown in FIG. 7B, the energy is applied to the bonding films 31 and 32 in the pre-contacted body. When the energy is applied to the bonding films 31 and 32 which make contact with each other, bonding property is developed on the bonding films 31 and 32.

As a result, the base member 1a and the base member 1b are bonded to each other due to the bonding property developed to the bonding films 31 and 32, to thereby obtain a bonded body 5 as shown in FIG. 7C. In this regard, it is to be noted that the energy may be applied to the bonding films 31 and 32 by any method including, e.g., the methods described in the first embodiment.

In this embodiment, it is preferred that at least one method selected from the group comprising a method in which an energy beam is irradiated on the bonding films 31 and 32, a method in which the bonding films 31 and 32 are heated, and a method in which a compressive force (physical energy) is applied to the bonding films 31 and 32 is used as the method of applying the energy to the bonding films 31 and 32.

The reason why these methods are preferred as the energy application method is that they are capable of relatively easily and efficiently applying the energy to the bonding films 31 and 32. Among these methods, the same method as employed in the first embodiment can be used as the method in which the energy beam is irradiated on the bonding films 31 and 32.

In this case, the energy beam is transmitted through the substrate 21 and is irradiated on the bonding films 31 and 32, or the energy beam is transmitted through the opposite substrate 22 and is irradiated on the bonding films 31 and 32. For this reason, between the substrate 21 and the opposite substrate 22, the substrate on which the energy beam is irradiated has preferably transparency.

On the other hand, in the case where the energy is applied to the bonding films 31 and 32 by heating the bonding films 31 and 32, a heating temperature is preferably in the range of about 25 to 100° C., and more preferably in the range of about 50 to 100° C. If the bonding films 31 and 32 are heated at a temperature of the above range, it is possible to reliably activate the bonding films 31 and 32 while reliably preventing the substrate 21 and the opposite substrate 22 from being thermally altered or deteriorated.

Further, a heating time is set great enough to remove the elimination groups 303 included in the bonding films 31 and 32. Specifically, the heating temperature may be preferably in the range of about 1 to 30 minutes if the heating temperature is set to the above mentioned range.

Furthermore, the bonding films 31 and 32 may be heated by any method. Examples of the heating method include various kinds of methods such as a method using a heater, a method of irradiating an infrared ray and a method of making contact with a flame.

In the case of using the method of irradiating the infrared ray, it is preferred that the substrate 21 or the opposite substrate 22 is made of a light-absorbing material. This ensures that the substrate 21 or the opposite substrate 22 can generate heat efficiently when the infrared ray is irradiated thereon. As a result, it is possible to efficiently heat the bonding films 31 and 32.

Further, in the case of using the method using the heater or the method of making contact with the flame, it is preferred that, the substrate 21 and the opposite substrate 22 are made of a material that exhibits superior thermal conductivity. This makes it possible to efficiently transfer the heat to the bonding films 31 and 32 through the substrate 21 or the opposite substrate 22, thereby efficiently heating the bonding films 31 and 32.

Furthermore, in the case where the energy is applied to the bonding films 31 and 32 by applying the compressive force to the bonding films 31 and 32, it is preferred that the base member 1a and the base member 1b are compressed against each other. Specifically, a pressure in compressing them is preferably in the range of about 0.2 to 10 MPa, and more preferably in the range of about 1 to 5 MPa.

This makes it possible to easily apply appropriate energy to the bonding films 31 and 32 by merely performing a compressing operation, which ensures that a sufficiently high bonding properties with respect to the substrate 21 and the opposite substrate 22 are developed in the bonding films 31 and 32, respectively. Although the pressure may exceed the above upper limit value, it is likely that damages and the like occur in the substrate 21 and the opposite substrate 22, depending on the constituent materials thereof.

Further, a compressing time is not particularly limited to a specific value, but is preferably in the range of about 10 seconds to 30 minutes. In this regard, it is to be noted that the compressing time can be suitably changed, depending on magnitude of the compressive force. Specifically, the compressing time can be shortened as the compressive force becomes greater.

In the manner described above, it is possible to obtain a bonded body 5 in which the base member 1a is bonded to the base member 1b.

After the bonded body 5 has been obtained, if necessary, at least one step of three steps <4A>, <4B>, and <4C> in the first embodiment may be carried out to the bonded body 5.

### Third Embodiment

Next, a description will be made on a third embodiment of each of a bonded body and a bonding method of the present invention.

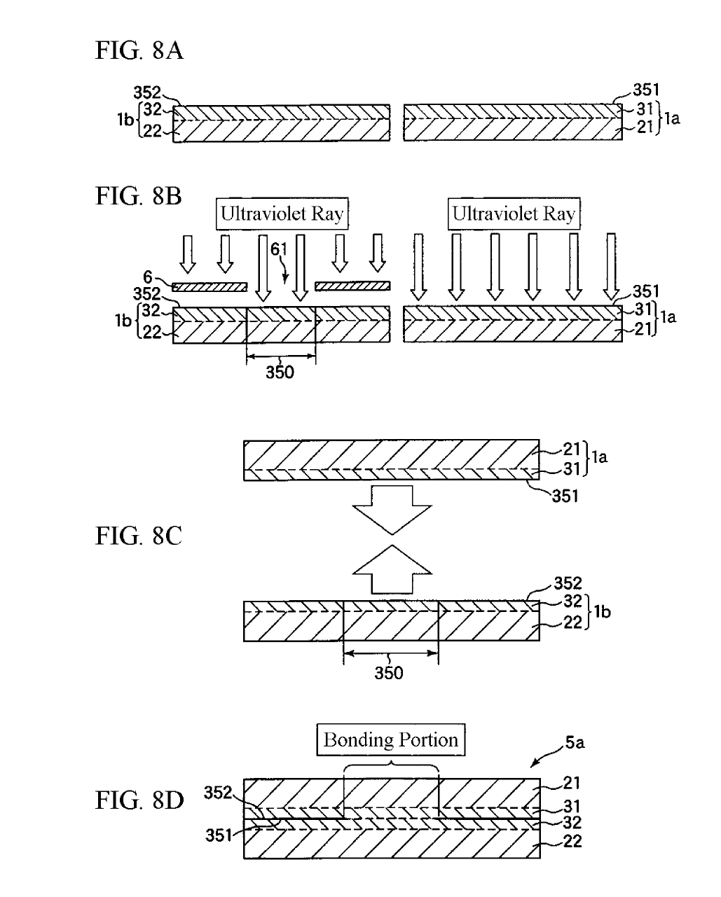

FIGS. 8A to 8D are longitudinal sectional views for explaining a third embodiment of a bonding method according to the present invention of bonding a substrate to an opposite substrate. In this regard, it is to be noted that in the following description, an upper side in each of FIGS. 8A to 8D will be referred to as “upper” and a lower side thereof will be referred to as “lower”.

Hereinafter, the bonding method according to the third embodiment will be described by placing emphasis on the points differing from the first and second embodiments, with the same matters omitted from the description.

The bonding method according to this embodiment is the same as that of the first embodiment, except that two base members 1a and 1b each having a bonding film 31 or a bonding film 32 are prepared, a surface 351 of the bonding film 31 thereof and only a predetermined region 350 of the bonding film 32 thereof are activated selectively, the two base members 1a and 1b are laminated together so that the bonding films 31 and 32 are in contact with each other, and the base members 1a and 1b are partially bonded to each other at the predetermined region 350.

In other words, the bonding method according to this embodiment includes a step of preparing (providing) the two base members 1a and 1b each having the bonding film 31 or the bonding film 32, a step of applying the energy to different regions (the entire of the surface 351 and the predetermined region 350 of the surface 352) of the bonding films 31 and 32 of the two base members 1a and 1b so that the different regions are activated, and a step of making the base members 1a and 1b contact with each other between the bonding films 31 and 32 so that they are partially bonded together at the predetermined region 350, to thereby obtain a bonded body 5a.

Hereinafter, the respective steps of the bonding method according to this embodiment will be described one after another.

[1] First, the base member 1a is prepared in the same manner as in the first embodiment (see FIG. 8A).

[2] Next, as shown in FIG. 8B, the energy is applied to the entirety of the surface 351 of the bonding film 31 of the base member 1a.

In this way, the bonding film 31 is activated, that is, bonding property is developed on the entirety of the surface 351 of the bonding film 31.

On the other hand, the base member 1b is prepared. Next, the energy is selectively applied to the predetermined region 350 of the surface 352 of the bonding film 32 of the base member 1b. The method of selectively applying the energy to the predetermined region 350 is not limited to a specific method, but is preferably a method of irradiating an energy beam on the bonding film 32. This is because it is possible to relatively easily and efficiently apply the energy to the bonding film 32.

Further, in this embodiment, it is preferred that energy beams having high directionality such as a laser beam and an electron beam are used as the energy beam. Use of these energy beams makes it possible to selectively and easily irradiate the energy beam on the predetermined region 350 by irradiating it in a target direction.

Even in the case where an energy beam with low directionality is used, it is possible to selectively irradiate the energy beam on the predetermined region 350 of the surface 352 of the bonding film 32, if radiation thereof is performed by covering (shielding) a region other than the predetermined region 350 to which the energy beam is to be irradiated.

Specifically, as shown in FIG. 8B, a mask 6 having a window portion 61 whose shape corresponds to a shape of the predetermined region 350 may be provided above the surface 352 of the bonding film 32. Then, the energy beam may be irradiated through the mask 6. By doing so, it is easy to selectively irradiate the energy beam on the predetermined region 350.

When the energy is applied to the bonding films 31 and 32, respectively, the elimination groups 303 shown in FIG. 3 are removed from the silicon atoms of the Si-skeleton 301 included in each of the bonding films 31 and 32. After the elimination groups 303 have been removed, the active hands 304 are generated in the vicinity of the surfaces 351 and 352 and the insides of the bonding films 31 and 32 as shown in FIG. 4.

In this state, the bonding films 31 and 32 are activated, that is, the bonding property is developed in the entirety of the surface 351 of the bonding film 31 and in the predetermined region 350 of the surface 352 of the bonding film 32, respectively.

In contrast, little or no bonding property is developed in a region of the bonding film 32 other than the predetermined region 350. The base members 1a and 1b each having the above state are rendered partially bondable to each other in the predetermined region 350.

[3] Then, as shown in FIG. 8C, the base members 1a and 1b are laminated together so that the bonding films 31 and 32 each having the bonding property thus developed make close contact with each other, to thereby obtain a bonded body 5a as shown in FIG. 8D.

In the bonded body 5a thus obtained, the base members 1a and 1b are not bonded together in the entire of an interface therebetween, but partially bonded together only in a partial region (the predetermined region 350). During this bonding operation, it is possible to easily select a bonded region by merely controlling an energy application region of the bonding film 32. This makes it possible to easily control, e.g., the bonding strength between the base members 1a and 1b in the bonded body 5a.

Further, it is also possible to reduce local concentration of stress which would be generated in the bonded portion by suitably controlling an area and shape of the bonded portion (the predetermined region 350) of the base members 1a and 1b shown in FIG. 8D.

This makes it possible to reliably bond the base members 1a and 1b together, e.g., even in the case where the substrate 21 and the opposite substrate 22 exhibit a large difference in their thermal expansion coefficients.

In addition, in the bonded body 5a, a tiny gap is generated (or remains) between the base members 1a and 1b in the region other than the predetermined region 350. This means that it is possible to easily form closed spaces, flow paths or the like between the base members 1a and 1b by suitably changing the shape of the predetermined region 350.

As described above, it is possible to adjust the bonding strength between the base members 1a and 1b and separating strength (splitting strength) therebetween by controlling the area of the bonded portion (the predetermined region 350) between the base members 1a and 1b.

From this standpoint, it is preferred that, in the case of producing an easy-to-separate bonded body 5a, the bonding strength between the base members 1a and 1b is set enough for the human hands to separate the bonded body 5a. By doing so, it becomes possible to easily separate the bonded body 5a without having to use any device or tool.

In the manner described above, it is possible to obtain the bonded body 5a.

If necessary, the bonded body 5a thus obtained may be subjected to at least one of the steps [4A], [4B] and [4C] in the first embodiment.

For example, if the bonded body 5a is heated while pressuring the same, the substrates 21 and 22 in the bonded body 5a come closer to each other. This accelerates dehydration and condensation of the hydroxyl groups and/or bonding of the dangling bonds in the interface between the bonding films 31 and 32. Thus, unification (bonding) of the bonding films 31 and 32 is further progressed. As a result, it is possible to obtain a bonded body 5a having a substantially completely united bonding film.

At this time, the tiny gap is generated (or remains) in the region (a non-bonding region), other than the predetermined region 350, of the interface between the surface 351 of the bonding film 31 and the surface 352 of the bonding film 32 in the bonded body 5a. Therefore, it is preferred that the pressuring and heating of the bonded body 5a is performed under the conditions in that the bonding films 31 and 32 are not bonded together in the region other than the predetermined region 350.

Taking the above situations into account, it is preferred that the predetermined region 350 is preferentially subjected to at least one of the steps [4A], [4B] and [4C] in the first embodiment, when such a need arises. This makes it possible to prevent the bonding films 31 and 32 from being involuntarily bonded together in the region other than the predetermined region 350.

### Fourth Embodiment

Next, a description will be made on a fourth embodiment of each of a bonded body and a bonding method of the present invention.

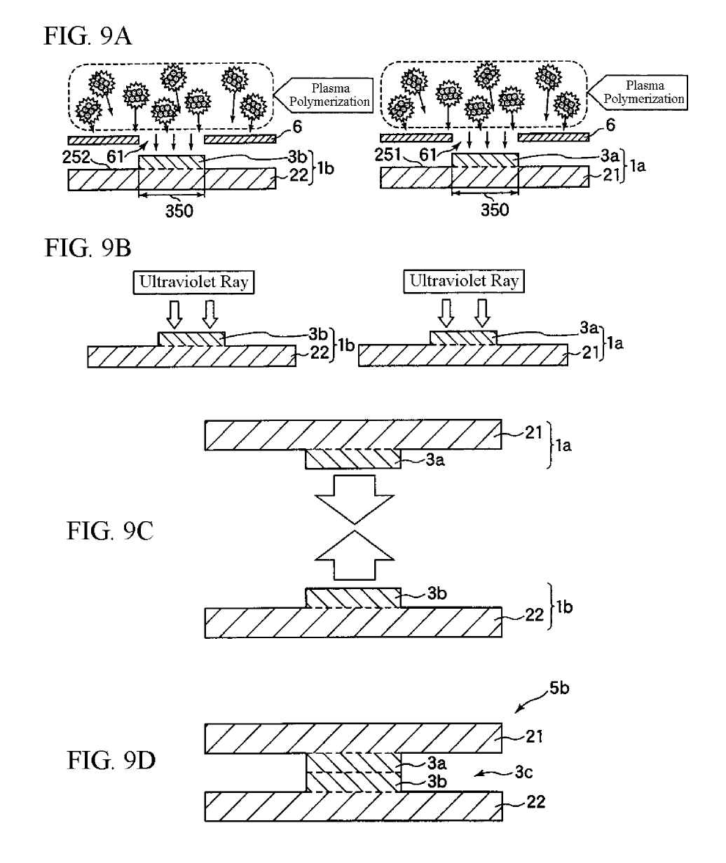

FIGS. 9A to 9D are longitudinal sectional views for explaining a fourth embodiment of a bonding method according to the present invention of bonding a substrate to an opposite substrate. In this regard, it is to be noted that in the following description, an upper side in each of FIGS. 9A to 9D will be referred to as “upper” and a lower side thereof will be referred to as “lower”.

Hereinafter, the bonding method according to the fourth embodiment will be described by placing emphasis on the points differing from the first to third embodiments, with the same matters omitted from description.

The bonding method according to this embodiment is the same as that of the first embodiment, except that the base members 1a and 1b are obtained by selectively forming bonding films 3a and 3b only on the predetermined regions 350 of upper surfaces 251 and 252 of substrates 21 and 22, and the base members 1a and 1b are partially bonded together through the bonding films 3a and 3b thereof.

In other words, the bonding method according to this embodiment includes a step of preparing (providing) base members 1a and 1b each having the substrate 21 or 22 and the bonding film 3a or 3b formed on a predetermined region 350 of the substrates 21 or 22, a step of applying the energy to the bonding films 3a and 3b of the base members 1a and 1b so that they are activated, and a step of making the base members 1a and 1b close contact with each other between the bonding films 3a and 3b so that they are partially bonded together at the predetermined region 350, to thereby obtain a bonded body 5b.

Hereinafter, the respective steps of the bonding method according to this embodiment will be described one after another.

[1] First, as shown in FIG. 9A, masks 6 each having a window 61 whose shape corresponds to a shape of the predetermined region 350 are respectively provided above the substrates 21 and 22.

Then, the bonding films 3a and 3b are respectively formed on the upper surfaces 251 and 252 of the substrates 21 and 22 through the masks 6. As shown in FIG. 9A, in the case where a plasma polymerization method is used as the method of forming the bonding films 3a and 3b, by applying a polymerized matter produced by the plasma polymerization method onto the upper surfaces 251 and 252 of the substrates 21 and 22 through the masks 6, the polymerized matter is selectively deposited on the predetermined regions 350 of the upper surfaces 251 and 252 to thereby form the bonding films 3a and 3b thereon.

As a result, it is possible to form the bonding films 3a and 3b on the predetermined regions 350 of the upper surfaces 251 and 252 of the substrates 21 and 22, respectively.

[2] Next, as shown in FIG. 9B, the energy is applied to the bonding films 3a and 3b, respectively. By doing so, bonding property is developed in each of the bonding films 3a and 3b.

During the application of the energy in this step, the energy may be applied selectively to the bonding films 3a and 3b or to the entirety of the upper surfaces 251 and 252 of the substrates 21 and 22 including the bonding films 3a and 3b. In this regard, it is to be noted that the energy may be applied to the bonding films 3a and 3b by any method including, e.g., the methods described in the first embodiment.

[3] Next, as shown in FIG. 9C, the base members 1a and 1b are laminated together so that the bonding films 3a and 3b each having the bonding property thus developed make close contact with each other. This makes it possible to obtain a bonded body 5b as shown in FIG. 9D.

In the bonded body 5b thus obtained, the base members 1a and 1b are not bonded together in the entire of an interface therebetween, but partially bonded together only in a partial region (the predetermined region 350). During the formations of the bonding films 3a and 3b, it is possible to easily select a bonded region by merely controlling the film formation regions. This makes it possible to easily control, e.g., the bonding strength between the base members 1a and 1b.

In addition, between the substrates 21 and 22 in the bonded body 5b, a gap 3c having a size corresponding to a total thickness of the bonding films 3a and 3b is formed in the region other than the predetermined region 350 (see FIG. 9D).

This means that it is possible to easily form closed spaces, flow paths or the like each having a desired shape between the substrates 21 and 22 by suitably changing the shape of the predetermined region 350 and the total thickness of the bonding films 3a and 3b.

In the manner described above, it is possible to obtain the bonded body 5b. If necessary, the bonded body 5b thus obtained may be subjected to at least one of the steps [4A], [4B] and [4C] in the first embodiment.

For example, if the bonded body 5b is heated while pressuring the same, the substrates 21 and 22 in the bonded body 5b come closer to each other. This accelerates dehydration and condensation of the hydroxyl groups and/or bonding of the dangling bonds in the interface between the bonding films 3a and 3b. Thus, unification (bonding) of the bonding films 3a and 3b is further progressed in the bonded portion formed in the predetermined region 350. Eventually, the bonding films 3a and 3b are substantially completely united.

The bonding methods of the respective embodiments described above can be used in bonding different kinds of members together.

Examples of an article (a bonded body) to be manufactured by these bonding methods include: semiconductor devices such as a transistor, a diode and a memory; piezoelectric devices such as a crystal oscillator and a surface acoustic wave device; optical devices such as a reflecting mirror, an optical lens, a diffraction grating and an optical filter; photoelectric conversion devices such as a solar cell; semiconductor substrates having semiconductor devices mounted thereon; insulating substrates having wirings or electrodes formed thereon; ink-jet type recording heads; parts of micro electromechanical systems such as a micro reactor and a micro mirror; sensor parts such as a pressure sensor and an acceleration sensor; package parts of semiconductor devices or electronic components; recording media such as a magnetic recording medium, a magneto-optical recording medium and an optical recording medium; parts for display devices such as a liquid crystal display device, an organic EL device and an electrophoretic display device; parts for fuel cells; and the like.

Droplet Ejection Head

Now, a description will be made on an embodiment of a droplet ejection head in which the bonded body according to the present invention is used.

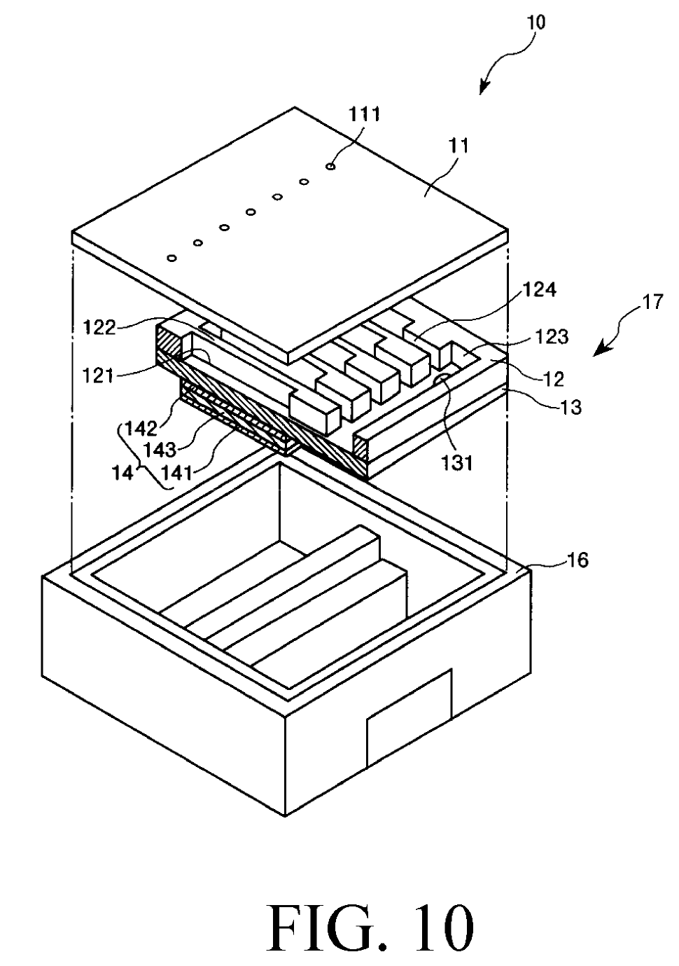

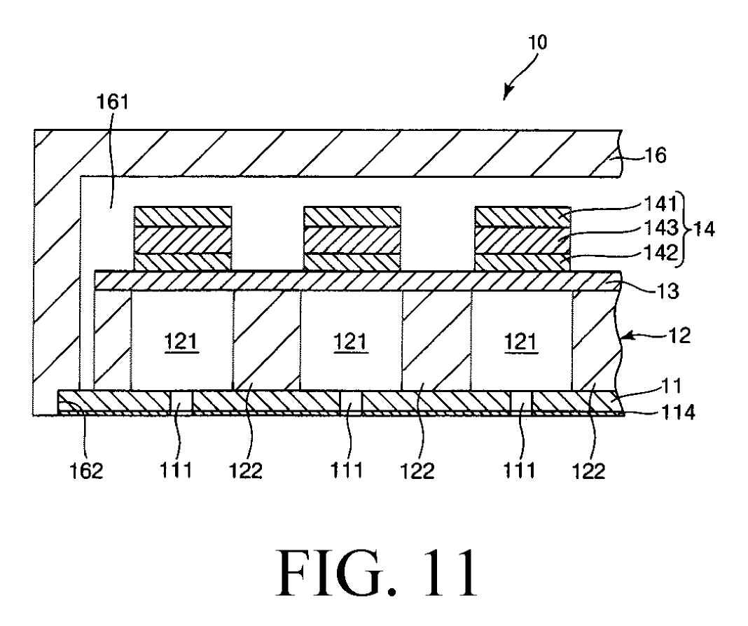

FIG. 10 is an exploded perspective view showing an ink jet type recording head (a droplet ejection head) in which the bonded body according to the present invention is used. FIG. 11 is a section view illustrating major parts of the ink jet type recording head shown in FIG. 10.

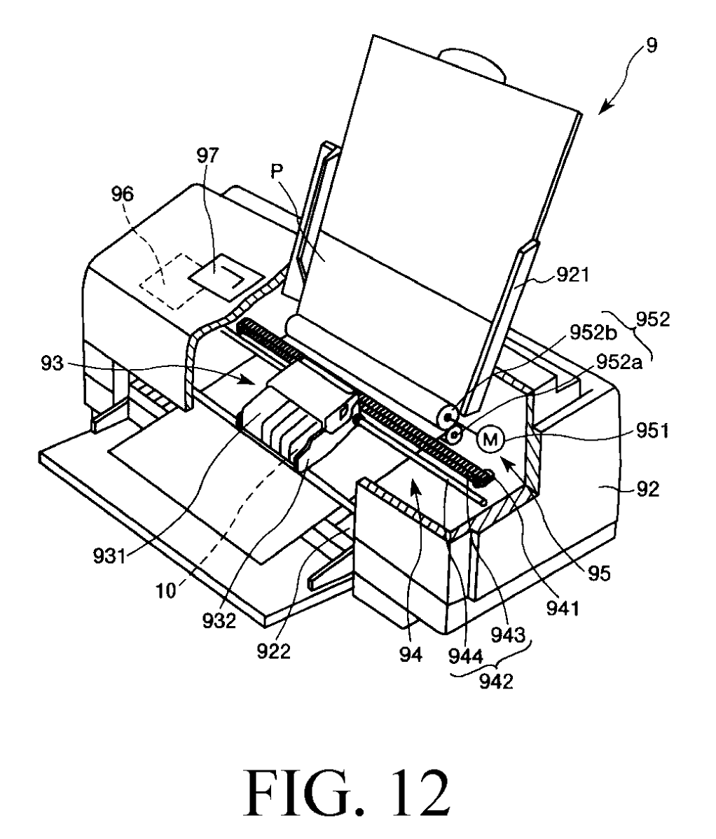

FIG. 12 is a schematic view showing one embodiment of an ink jet printer equipped with the ink jet type recording head shown in FIG. 10. In FIG. 10, the ink jet type recording head is shown in an inverted state as distinguished from a typical use state.

The ink jet type recording head 10 shown in FIG. 10 is mounted to the ink jet printer 9 shown in FIG. 12.

The ink jet printer 9 shown in FIG. 12 includes a printer body 92, a tray 921 provided in the upper rear portion of the printer body 92 for holding recording paper sheets P, a paper discharging port 922 provided in the lower front portion of the printer body 92 for discharging the recording paper sheets P therethrough, and an operation panel 97 provided on the upper surface of the printer body 92.

The operation panel 97 is formed from, e.g., a liquid crystal display, an organic EL display, an LED lamp or the like. The operation panel 97 includes a display portion (not shown) for displaying an error message and the like and an operation portion (not shown) formed from various kinds of switches.

Within the printer body 92, there are provided a printing device (a printing means) 94 having a reciprocating head unit 93, a paper sheet feeding device (a paper sheet feeding means) 95 for feeding the recording paper sheets P into the printing device 94 one by one and a control unit (a control means) 96 for controlling the printing device 94 and the paper sheet feeding device 95.

Under the control of the control unit 96, the paper sheet feeding device 95 feeds the recording paper sheets P one by one in an intermittent manner. The recording paper sheet P passes near the lower portion of the head unit 93. At this time, the head unit 93 makes reciprocating movement in a direction generally perpendicular to the feeding direction of the recording paper sheet P, thereby printing the recording paper sheet P.

In other words, an ink jet type printing operation is performed, during which time the reciprocating movement of the head unit 93 and the intermittent feeding of the recording paper sheets P act as primary scanning and secondary scanning, respectively.

The printing device 94 includes a head unit 93, a carriage motor 941 serving as a driving power source of the head unit 93 and a rotated by the carriage motor 941 for reciprocating the head unit 93.

The head unit 93 includes an ink jet type recording head 10 (hereinafter, simply referred to as “a head 10”) having a plurality of formed in the lower portion thereof, an ink cartridge 931 for supplying ink to the head 10 and a carriage 932 carrying the head 10 and the ink cartridge 931.

Full color printing becomes available by using, as the ink cartridge 931, a cartridge of the type filled with ink of four colors, i.e., yellow, cyan, magenta and black.

The reciprocating mechanism 942 includes a carriage guide shaft 943 whose opposite ends are supported on a frame (not shown) and a timing belt 944 extending parallel to the carriage guide shaft 943.

The carriage 932 is reciprocatingly supported by the carriage guide shaft 943 and fixedly secured to a portion of the timing belt 944.

If the timing belt 944 wound around a pulley is caused to run in forward and reverse directions by operating the carriage motor 941, the head unit 93 makes reciprocating movement along the carriage guide shaft 943. During this reciprocating movement, an appropriate amount of ink is ejected from the head 10 to print the recording paper sheets P.

The paper sheet feeding device 95 includes a paper sheet feeding motor 951 serving as a driving power source thereof and a pair of paper sheet feeding rollers 952 rotated by means of the paper sheet feeding motor 951.

The paper sheet feeding rollers 952 include a driven roller 952a and a driving roller 952b, both of which face toward each other in a vertical direction, with a paper sheet feeding path (the recording paper sheet P) remained therebetween. The driving roller 952b is connected to the paper sheet feeding motor 951.

Thus, the paper sheet feeding rollers 952 are able to feed the plurality of recording paper sheets P, which are held in the tray 921, toward the printing device 94 one by one. In place of the tray 921, it may be possible to employ a construction that can removably hold a paper sheet feeding cassette containing the recording paper sheets P.

The control unit 96 is designed to perform printing by controlling the printing device 94 and the paper sheet feeding device 95 based on the printing data inputted from a host computer, e.g., a personal computer or a digital camera.

Although not shown in the drawings, the control unit 96 is mainly comprised of a memory that stores a control program for controlling the respective parts and the like, a piezoelectric element driving circuit for driving piezoelectric elements (vibration sources) 14 to control an ink ejection timing, a driving circuit for driving the printing device 94 (the carriage motor 941), a driving circuit for driving the paper sheet feeding device 95 (the paper sheet feeding motor 951), a communication circuit for receiving printing data from a host computer, and a CPU electrically connected to the memory and the circuits for performing various kinds of control with respect to the respective parts.

Electrically connected to the CPU are a variety of sensors capable of detecting, e.g., the remaining amount of ink in the ink cartridge 931 and the position of the head unit 93.

The control unit 96 receives printing data through the communication circuit and then stores them in the memory. The CPU processes these printing data and outputs driving signals to the respective driving circuits, based on the data thus processed and the data inputted from the variety of sensors. Responsive to these signals, the piezoelectric elements 14, the printing device 94 and the paper sheet feeding device 95 come into operation, thereby printing the recording paper sheets P.

Hereinafter, the head 10 will be described in detail with reference to FIGS. 10 and 11.

The head 10 includes a head main body 17 and a base body 16 for receiving the head main body 17. The head main body 17 includes a nozzle plate 11, an ink chamber base plate 12, a vibration plate 13 and a plurality of piezoelectric elements (vibration sources) 14 bonded to the vibration plate 13. The head 10 constitutes a piezo jet type head of on-demand style.

The nozzle plate 11 is made of, e.g., a silicon-based material such as SiO₂, SiN or quartz glass, a metallic material such as Al, Fe, Ni, Cu or alloy containing these metals, an oxide-based material such as alumina or ferric oxide, a carbon-based material such as carbon black or graphite. and the like.

A plurality of nozzle holes 111 for ejecting ink droplets therethrough is formed in the nozzle plate 11. The pitch of the nozzle holes 111 is suitably set according to the degree of printing accuracy.

The ink chamber base plate 12 is fixed or secured to the nozzle plate 11. In the ink chamber base plate 12, there are formed a plurality of ink chambers (cavities or pressure chambers) 121, a reservoir chamber 123 for reserving ink supplied from the ink cartridge 931 and a plurality of supply ports 124 through which ink is supplied from the reservoir chamber 123 to the respective ink chambers 121. These chambers 121, 123 and 124 are defined by the nozzle plate 11, the side walls (barrier walls) 122 and the below mentioned vibration plate 13.

The respective ink chambers 121 are formed into a reed shape (a rectangular shape) and are arranged in a corresponding relationship with the respective nozzle holes 111. Volume of each of the ink chambers 121 can be changed in response to vibration of the vibration plate 13 as described below. Ink is ejected from the ink chambers 121 by virtue of this volume change.

As a base material of which the ink chamber base plate 12 is made, it is possible to use, e.g., a monocrystalline silicon substrate, various kinds of glass substrates or various kinds of resin substrates. Since these substrates are all generally used in the art, use of these substrates makes it possible to reduce manufacturing cost of the head 10.

The vibration plate 13 is bonded to the opposite side of the ink chamber base plate 12 from the nozzle plate 11. The plurality of piezoelectric elements 14 are provided on the opposite side of the vibration plate 13 from the ink chamber base plate 12.

In a predetermined position of the vibration plate 13, a communication hole 131 is formed through a thickness of the vibration plate 13. Ink can be supplied from the ink cartridge 931 to the reservoir chamber 123 through the communication hole 131.

Each of the piezoelectric elements 14 includes an upper electrode 141, a lower electrode 142 and a piezoelectric body layer 143 interposed between the upper electrode 141 and the lower electrode 142. The piezoelectric elements 14 are arranged in alignment with the generally central portions of the respective ink chambers 121.

The piezoelectric elements 14 are electrically connected to the piezoelectric element driving circuit and are designed to be operated (vibrated or deformed) in response to the signals supplied from the piezoelectric element driving circuit.

The piezoelectric elements 14 act as vibration sources. The vibration plate 13 is vibrated by operation of the piezoelectric elements 14 and has a function of instantaneously increasing internal pressures of the ink chambers 121.

The base body 16 is made of, e.g., various kinds of resin materials or various kinds of metallic materials. The nozzle plate 11 is fixed to and supported by the base body 16. Specifically, in a state that the head main body 17 is received in a recess portion 161 of the base body 16, an edge of the nozzle plate 11 is supported on a shoulder 162 of the base body 16 extending along an outer circumference of the recess portion 161.

When bonding the nozzle plate 11 and the ink chamber base plate 12, the ink chamber base plate 12 and the vibration plate 13, and the nozzle plate 11 and the base body 16 as mentioned above, the bonding method of the present invention is used in at least one bonding point.

In other words, the bonded body of the present invention is used in at least one of a bonded body in which the nozzle plate 11 and the ink chamber base plate 12 are bonded together, a bonded body in which the ink chamber base plate 12 and the vibration plate 13 are bonded together, and a bonded body in which the nozzle plate 11 and the base body 16 are bonded together.

The head 10 described above exhibits increased bonding strength and chemical resistance in a bonding surface of the bonded portion, which in turn leads to increased durability and liquid tightness against the ink reserved in the respective ink chambers 121. As a result, the head 10 is rendered highly reliable.

Furthermore, highly reliable bonding is available even at an extremely low temperature. This is advantageous in that a head with an increased area can be fabricated from those materials having different linear expansion coefficients.

With the head 10 set forth above, no deformation occurs in the piezoelectric body layer 143 in the case where a predetermined ejection signal has not been inputted from the piezoelectric element driving circuit, that is, a voltage has not been applied between the upper electrode 141 and the lower electrode 142 of each of the piezoelectric elements 1.

For this reason, no deformation occurs in the vibration plate 13 and no change occurs in the volumes of the ink chambers 121. Therefore, ink droplets have not been ejected from the nozzle holes 111.

On the other hand, the piezoelectric body layer 143 is deformed in the case where a predetermined ejection signal is inputted from the piezoelectric element driving circuit, that is, a voltage is applied between the upper electrode 141 and the lower electrode 142 of each of the piezoelectric elements 1.

Thus, the vibration plate 13 is heavily deflected to change the volumes of the ink chambers 121. At this moment, the pressures within the ink chambers 121 are instantaneously increased and ink droplets are ejected from the nozzle holes 111.

When one ink ejection operation has ended, the piezoelectric element driving circuit ceases to apply a voltage between the upper electrode 141 and the lower electrode 142. Thus, the piezoelectric elements 14 are returned substantially to their original shapes, thereby increasing the volumes of the ink chambers 121.

At this time, a pressure acting from the ink cartridge 931 toward the nozzle holes 111 (a positive pressure) is imparted to the ink. This prevents an air from entering the ink chambers 121 through the nozzle holes 111, which ensures that the ink is supplied from the ink cartridge 931 (the reservoir chamber 123) to the ink chambers 121 in a quantity corresponding to the quantity of ink ejected.

By sequentially inputting ejection signals from the piezoelectric element driving circuit to the piezoelectric elements 14 lying in target printing positions, it is possible to print an arbitrary (desired) letter, figure or the like.

The head 10 may be provided with thermoelectric conversion elements in place of the piezoelectric elements 14. In other words, the head 10 may have a configuration in which ink is ejected using the thermal expansion of a material caused by thermoelectric conversion elements (which is sometimes called a bubble jet method wherein the term “bubble jet” is a registered trademark).

In the head 10 configured as above, a film 114 is formed on the nozzle plate 11 in an effort to impart liquid repellency thereto. By doing so, it is possible to reliably prevent ink droplets from adhering to peripheries of the nozzle holes 111, which would otherwise occur when the ink droplets are ejected from the nozzle holes 111.

As a result, it becomes possible to make sure that the ink droplets ejected from the nozzle holes 111 are reliably landed (hit) on target regions.

Although the bonded body and the bonding method according to the present invention have been described above based on the embodiments illustrated in the drawings, the present invention is not limited thereto.

As an alternative example, the bonding method according to the present invention may be a combination of two or more of the foregoing embodiments. If necessary, one or more arbitrary step may be added in the bonding method according to the present invention.

Further, although cases that two substrates (e.g., the substrate and the opposite substrate) are bonded together through the bonding film has been described in the above embodiments, the bonding method of the present invention can be used in a case that three or more substrates are bonded together.

### EXAMPLES

Next, a description will be made on a number of concrete examples of the present invention.

1. Manufacturing Bonded Body

Hereinafter, twenty bonded bodies are manufactured in each of Examples and Comparative Examples. In this regard, it is to be noted that in each bonded body obtained in the Examples 16 to 23 and the Comparative Examples 16 to 20 and 24 to 26, a part of a surfaces of a substrate and a part of a surface of an opposite substrate were bonded to each other.

### Example 1

First, a monocrystalline silicon substrate having a length of 20 mm, a width of 20 mm and an average thickness of 1 mm was prepared as a substrate. A glass substrate having a length of 20 mm, a width of 20 mm and an average thickness of 1 mm was prepared as an opposite substrate.

Subsequently, the monocrystalline silicon substrate was set in the chamber 111 of the film forming apparatus 100 shown in FIG. 5 and subjected to a surface treatment using oxygen plasma.

Next, a plasma polymerization film (bonding film) having an average thickness of 200 nm was formed on the surface-treated surface of the monocrystalline silicon substrate. In this regard, it is to be noted that the film forming conditions were as follows.

Film Forming Conditions

A composition of a raw gas is octamethyltrisiloxane, a flow rate of the raw gas is 50 sccm, a composition of a carrier gas is argon, a flow rate of the carrier gas is 100 sccm, an output of a high-frequency electricity is 100 W, a density of the high-frequency electricity is 25 W/cm², a pressure inside the chamber is 1 Pa (low vacuum), a time of forming a film is 15 minutes, and a temperature of the monocrystalline silicon substrate is 20° C.

The plasma polymerization film formed as described above was constituted of a polymer of octamethyltrisiloxane (raw gas). The polymer contained siloxane bonds, a Si-skeleton of which constituent atoms were bonded, and alkyl groups (elimination groups) in a chemical structure thereof. In this way, a base member in which the plasma polymerization film was formed on the monocrystalline silicon substrate was obtained.

Likewise, after glass substrate was subjected to the surface treatment using the oxygen plasma, a plasma polymerization film was also formed on the surface-treated surface of the glass substrate. In this way, a base member was obtained.

Then, an ultraviolet ray was irradiated on the obtained plasma polymerization films under the following conditions.

Ultraviolet Ray Irradiation Conditions

A composition of an atmospheric gas is an atmosphere (air), a temperature of the atmospheric gas is 20° C., a pressure of the atmospheric gas is atmospheric pressure (100 kPa), a wavelength of the ultraviolet ray is 172 nm, and an irradiation time of the ultraviolet ray is 5 minutes.

Next, after 1 minute of the ultraviolet ray irradiation, the monocrystalline silicon substrate was laminated to the glass substrate so that the surface of the plasma polymerization film of the monocrystalline silicon substrate, to which the ultraviolet ray had been irradiated, was in contact with the surface of the plasma polymerization film of the glass substrate, to which the ultraviolet ray had been irradiated. As a result, a bonded body was obtained.

Then, the bonded body thus obtained was heated at a temperature of 80° C. while pressuring the same under a pressure of 3 MPa and was maintained for fifteen minutes to thereby increase bonding strength between the monocrystalline silicon substrate and the glass substrate.

### Example 2

In the Example 2, a bonded body was manufactured in the same manner as in the Example 1, except that the heating temperature was changed from 80° C. to 25° C. during the pressuring and heating of the bonded body obtained.

### Examples 3 to 12

In each of the Examples 3 to 12, a bonded body was manufactured in the same manner as in the Example 1, except that the constitute material of the substrate and the constitute material of the opposite substrate were changed to materials shown in Table 1.

### Example 13

First, in the same manner as in the Example 1, a monocrystalline silicon substrate (a substrate) and a glass substrate (an opposite substrate) were prepared and subjected to a surface treatment using oxygen plasma.

Then, a plasma polymerization film was formed on the surface-treated surface of each of the monocrystalline silicon substrate and the glass substrate in the same manner as in the Example 1.

In this way, obtained were two base members in which the plasma polymerization film was formed on each of the monocrystalline silicon substrate and the glass substrate.

Subsequently, the two base members were laminated together so that the plasma polymerization films of the two base members made contact with each other to thereby obtain a pre-contacted body.

Next, an ultraviolet ray was irradiated to the pre-contacted body from the side of the glass substrate under the following conditions.

Ultraviolet Ray Irradiation Conditions

A composition of an atmospheric gas is an atmosphere (air), a temperature of the atmospheric gas is 20° C., a pressure of the atmospheric gas is atmospheric pressure (100 kPa), a wavelength of the ultraviolet ray is 172 nm, and an irradiation time of the ultraviolet ray is 5 minutes.

In this way, the two base members were bonded to each other to thereby obtain a bonded body.

Then, the bonded body thus obtained was heated at a temperature of 80° C. while pressuring the same under a pressure of 3 MPa and was maintained for fifteen minutes to thereby increase bonding strength between the base members.

### Example 14

In the Example 14, a bonded body was manufactured in the same manner as in the Example 1, except that the output of the high-frequency electricity was changed to 150 W (output density of the high-frequency voltage was changed 37.5 W/cm²).

### Example 15

In the Example 15, a bonded body was manufactured in the same manner as in the Example 1, except that the output of the high-frequency electricity was changed to 200 W (output density of the high-frequency voltage was changed 50 W/cm²).

### Comparative Example 1

First, a monocrystalline silicon substrate having a length of 20 mm, a width of 20 mm and an average thickness of 1 mm was prepared as a substrate. A glass substrate having a length of 20 mm, a width of 20 mm and an average thickness of 1 mm was prepared as an opposite substrate.

Subsequently, the monocrystalline silicon substrate were set in the chamber 101 of the film forming apparatus 100 shown in FIG. 5 and subjected to a surface treatment using oxygen plasma.

Next, a plasma polymerization film having an average thickness of 200 nm was formed on the surface-treated surfaces of the monocrystalline silicon substrate. In this regard, it is to be noted that the film forming conditions were as follows.

Film Forming Conditions

A composition of a raw gas is octamethyltrisiloxane, a flow rate of the raw gas is 50 sccm, a composition of a carrier gas is argon, a flow rate of the carrier gas is 100 sccm, an output of a high-frequency electricity is 100 W, a density of the high-frequency electricity is 25 W/cm², a pressure inside the chamber is 1 Pa (low vacuum), a time of forming a film is 15 minutes, and a temperature of the monocrystalline silicon substrate is 20° C.

Then, an ultraviolet ray was irradiated on the obtained plasma polymerization film under the following conditions.

Ultraviolet Ray Irradiation Conditions

A composition of an atmospheric gas is an atmosphere (air), a temperature of the atmospheric gas is 20° C., a pressure of the atmospheric gas is atmospheric pressure (100 kPa), a wavelength of the ultraviolet ray is 172 nm, and a irradiation time of the ultraviolet ray is 5 minutes.

Next, after 1 minute of the ultraviolet ray irradiation, the monocrystalline silicon substrate was laminated to the glass substrate so that the surface of the plasma polymerization film of the monocrystalline silicon substrate, to which the ultraviolet ray had been irradiated, was in contact with the surface-treated surface of the glass substrate. As a result, a bonded body was obtained.

Then, the bonded body thus obtained was heated at a temperature of 80° C. while pressuring the same under a pressure of 3 MPa and was maintained for fifteen minutes to thereby increase bonding strength between the plasma polymerization film of the monocrystalline silicon substrate (base member) and the glass substrate.

### Comparative Example 2

In the Comparative Example 2, a bonded body was manufactured in the same manner as in the Comparative Example 1, except that the heating temperature was changed from 80° C. to 25° C. during the pressuring and heating of the bonded body obtained.

### Comparative Examples 3 to 12

In each of the Comparative Examples 3 to 12, a bonded body was manufactured in the same manner as in the Comparative Example 1, except that the constitute material of the substrate and the constitute material of the opposite substrate were changed to materials shown in Table 1.

### Comparative Example 13

First, in the same manner as in the Comparative Example 1, a monocrystalline silicon substrate (a substrate) and a glass substrate (an opposite substrate) were prepared and subjected to a surface treatment using oxygen plasma.

Then, a plasma polymerization film was formed on the surface-treated surfaces of the monocrystalline silicon substrate in the same manner as in the Comparative Example 1. In this way, obtained was a base member in which the plasma polymerization film was formed on the monocrystalline silicon substrate.

Subsequently, the monocrystalline silicon substrate and the glass substrate were laminated together so that the plasma polymerization film of the monocrystalline silicon substrate made contact with the surface-treated surface of the glass substrate to thereby obtain a pre-contacted body.

Next, an ultraviolet ray was irradiated to the pre-contacted body from the side of the glass substrate under the following conditions.

Ultraviolet Ray Irradiation Conditions

A composition of an atmospheric gas is an atmosphere (air), a temperature of the atmospheric gas is 20° C., a pressure of the atmospheric gas is atmospheric pressure (100 kPa), a wavelength of the ultraviolet ray is 172 nm, and an irradiation time of the ultraviolet ray is 5 minutes.

In this way, the monocrystalline silicon substrate and the glass substrate were bonded together through the polymerization film to thereby obtain a bonded body.

Then, the bonded body thus obtained was heated at a temperature of 80° C. while pressuring the same under a pressure of 3 MPa and was maintained for fifteen minutes to thereby increase bonding strength between the monocrystalline silicon substrate and the glass substrate.

### Comparative Example 14

In the Comparative Example 14, a bonded body was manufactured in the same manner as in the Comparative Example 1, except that the output of the high-frequency electricity was changed to 150 W (output density of the high-frequency voltage was changed 37.5 W/cm²).

### Comparative Example 15

In the Comparative Example 15, a bonded body was manufactured in the same manner as in the Comparative Example 1, except that the output of the high-frequency electricity was changed to 200 W (output density of the high-frequency voltage was changed 50 W/cm²).

### Example 16

First, a monocrystalline silicon substrate having a length of 20 mm, a width of 20 mm and an average thickness of 1 mm was prepared as a substrate. A glass substrate having a length of 20 mm, a width of 20 mm and an average thickness of 1 mm was prepared as an opposite substrate.

Subsequently, both of the monocrystalline silicon substrate and the glass substrate were set in the chamber 101 of the film forming apparatus 100 shown in FIG. 5, and subjected to a surface treatment using oxygen plasma.

Next, plasma polymerization films each having an average thickness of 200 nm were formed on the surface-treated surfaces of the monocrystalline silicon substrate and the glass substrate to obtain base members. In this regard, it is to be noted that the film forming conditions were as follows.

Film Forming Conditions

A composition of a raw gas is octamethyltrisiloxane, a flow rate of the raw gas is 50 sccm, a composition of a carrier gas is argon, a flow rate of the carrier gas is 100 sccm, an output of a high-frequency electricity is 100 W, a density of the high-frequency electricity is 25 W/cm², a pressure inside the chamber is 1 Pa (low vacuum), a time of forming a film is 15 minutes, and a temperature of the substrates is 20° C.

Then, an ultraviolet ray was irradiated on the obtained plasma polymerization films under the following conditions.

In this regard, it is to be noted that the ultraviolet ray was irradiated on the entirety of the surface of the plasma polymerization film provided on the monocrystalline silicon substrate and on a frame-shaped region having a width of 3 mm along a periphery of the surface of the plasma polymerization film provided on the glass substrate.

Ultraviolet Ray Irradiation Conditions

A composition of an atmospheric gas is an atmosphere (air), a temperature of the atmospheric gas is 20° C., a pressure of the atmospheric gas is atmospheric pressure (100 kPa), a wavelength of the ultraviolet ray is 172 nm, and an irradiation time of the ultraviolet ray is 5 minutes.

Subsequently, the monocrystalline silicon substrate and the glass substrate were laminated together so that the ultraviolet ray-irradiated surfaces of the plasma polymerization films made contact with each other to thereby obtain a bonded body.

Then, the bonded body thus obtained was heated at a temperature of 80° C. while pressuring the same under a pressure of 3 MPa and was maintained for fifteen minutes to thereby increase bonding strength between the plasma polymerization films.

### Example 17

In the Example 17, a bonded body was manufactured in the same manner as in the Example 16, except that the heating temperature was changed from 80° C. to 25° C. during the pressuring and heating of the bonded body obtained.

### Examples 18 to 23

In each of the Examples 18 to 23, a bonded body was manufactured in the same manner as in the Example 16, except that the constitute material of the substrate and the constitute material of the opposite substrate were changed to materials shown in Table 2.

### Comparative Example 16

First, a monocrystalline silicon substrate having a length of 20 mm, a width of 20 mm and an average thickness of 1 mm was prepared as a substrate. A stainless steel substrate having a length of 20 mm, a width of 20 mm and an average thickness of 1 mm was prepared as an opposite substrate.

Subsequently, the monocrystalline silicon substrate was set in the chamber 101 of the film forming apparatus 100 shown in FIG. 5 and subjected to a surface treatment using oxygen plasma.

Next, a plasma polymerization film having an average thickness of 200 nm was formed on the surface-treated surface of the monocrystalline silicon substrate in the same manner as in the Example 16.

In this way, obtained was a base member in which the plasma polymerization film was formed on the monocrystalline silicon substrate.

Then, an ultraviolet ray was irradiated on the plasma polymerization film in the same manner as in the Example 16. In this regard, it is to be noted that the ultraviolet ray was irradiated on a frame-shaped region having a width of 3 mm along a periphery of the surface of the plasma polymerization film.

Further, the stainless steel substrate was also subjected to the surface treatment using the oxygen plasma in the same manner as employed in the monocrystalline silicon substrate.

Subsequently, the base member and the stainless steel substrate were laminated together so that the ultraviolet ray-irradiated surface of the plasma polymerization film and the surface-treated surface of the stainless steel substrate made contact with each other to thereby obtain a bonded body.

Then, the bonded body thus obtained was heated at a temperature of 80° C. while pressuring the same under a pressure of 3 MPa and was maintained for fifteen minutes to thereby increase bonding strength between the plasma polymerization film and the stainless steel substrate.

### Comparative Example 17

In the Comparative Example 17, a bonded body was manufactured in the same manner as in the Comparative Example 16, except that the heating temperature was changed from 80° C. to 25° C. during the pressuring and heating of the bonded body obtained.

### Comparative Examples 18 to 20

In each of the Comparative Examples 18 to 20, a bonded body was manufactured in the same manner as in the Comparative Example 16, except that the constitute material of the substrate and the constitute material of the opposite substrate were changed to materials shown in Table 2.

### Comparative Examples 21 to 23

In each of the Comparative Examples 21 to 23, a bonded body' was manufactured in the same manner as in the Example 1, except that the constitute material of the substrate and the constitute material of the opposite substrate were changed to materials shown in Table 1, and the substrate and the opposite substrate were bonded to each other by using an epoxy-based adhesive.

### Comparative Examples 24 to 26

In each of the Comparative Examples 24 to 26, a bonded body was manufactured in the same manner as in the Example 16, except that the constitute material of the substrate and the constitute material of the opposite substrate were changed to materials shown in Table 2, and the substrate and the opposite substrate were partially bonded to each other by using an epoxy-based adhesive in regions each having a width of 3 mm along a periphery of each substrate.

### Comparative Example 27

In the Comparative Example 27, a bonded body was manufactured in the same manner as in the Example 1, except that the following bonding films were formed on a monocrystalline silicon substrate and a glass substrate instead of the plasma polymerization film.

First, prepared was a liquid material which contains a material having a polydimethylsiloxane skeleton as a silicone material and toluene and isobutanol as a solvent (“KR-251” produced by Shin-Etsu Chemical Co., Ltd., a viscosity (at 25° C.) is 18.0 mPa·S).

Subsequently, after a surface of the monocrystalline silicon substrate was subjected to a surface treatment using oxygen plasma, the liquid material was applied onto the surface-treated surface of the monocrystalline silicon substrate. Next, the applied liquid material was dried at room temperature (25° C.) for 24 hours to obtain a bonding film.

Likewise, after a surface of the glass substrate was subjected to the surface treatment using the oxygen plasma, a bonding film was formed on the surface-treated surface. An ultraviolet ray was irradiated to the surface of each of the bonding films.

Thereafter, the monocrystalline silicon substrate and the glass substrate were heated while pressing them so that the bonding films adhere to each other. In this way, a bonded body was obtained, in which the monocrystalline silicon substrate was bonded to the glass substrate through the bonding films.

### Comparative Examples 28 to 33

In each of the Comparative Examples 28 to 33, a bonded body was manufactured in the same manner as in the Comparative Example 27, except that the constituent materials of the substrate and the opposite substrate were changed to materials shown in Table 1.

### Comparative Example 34

In the Comparative Example 34, a bonded body was manufactured in the same manner as in the Example 1, except that the following bonding films were formed on a monocrystalline silicon substrate and a glass substrate instead of the plasma polymerization film.

First, after a surface of the monocrystalline silicon substrate was subjected to a surface treatment using oxygen plasma, a vapor of hexamethyldisilazane (HMDS) was applied to the surface-treated surface of the monocrystalline silicon substrate to obtain a bonding film constituted of HMDS.

Likewise, after a surface of the glass substrate was subjected to the surface treatment using the oxygen plasma, a bonding film constituted of HMDS was formed on the surface-treated surface of the glass substrate. An ultraviolet ray was irradiated to the surface of each of the bonding films.

Thereafter, the monocrystalline silicon substrate and the glass substrate were heated while pressing them so that the bonding films adhered to each other. In this way, a bonded body was obtained, in which the monocrystalline silicon substrate was bonded to the glass substrate through the bonding films.

2. Evaluation of Bonded Body

2.1 Evaluation of Bonding Strength (Splitting Strength)

Bonding strength was measured for each of the bonded bodies obtained in the Examples 1 to 23 and the Comparative Examples 1 to 34.

The measurement of the bonding strength was performed by trying removal of the substrate from the opposite substrate. That is, the measurement of the bonding strength was performed just before the substrate was removed from the opposite substrate. Further, the measurement of the bonding strength was performed just after the substrate and the opposite substrate were bonded to each other.

Furthermore, the bonded body, that a temperature cycle in the range of −40 to 125° C. was repeatedly performed thereto 100 times just after the substrate and the opposite substrate were bonded to each other, was used for the measurement of the bonding strength. The Result of the bonding strength was evaluated according to criteria described below.

In this regard, the bonding strength between the substrate and the opposite substrate in the bonded body which was obtained by partially bonding the surfaces of them to each other (bonded body defined in Table 2) was larger than the bonding strength between the substrate and the opposite substrate in the bonded body which was obtained by bonding the entire surfaces of them to each other (bonded body defined in Table 1).

Evaluation Criteria for Bonding Strength

A: 10 MPa (100 kgf/cm²) or more

B: 5 MPa (50 kgf/cm²) or more, but less than 10 MPa (100 kgf/cm²)

C: 1 MPa (10 kgf/cm²) or more, but less than 5 MPa (50 kgf/cm²)

D: less than 1 MPa (10 kgf/cm²)

2.2 Evaluation of Dimensional Accuracy

Dimensional accuracy in a thickness direction was measured for each of the bonded bodies obtained in the Examples 1 to 23 and the Comparative Examples 1 to 34.

The evaluation of the dimensional accuracy was performed by measuring a thickness of each corner portion of the bonded body having a squire shape, calculating a difference between a maximum value and a minimum value of the thicknesses measured, and evaluating the difference according to criteria described below.

Evaluation Criteria for Dimensional Accuracy

A: less than 10 μm

D: 10 μm or more

2.3 Evaluation of Chemical Resistance

Ten of the bonded bodies obtained in each of the Examples 1 to 23 and the Comparative Examples 1 to 34 were immersed in an ink for an ink-jet printer

(“HQ4”, produced by Seiko Epson Corporation), which was maintained at a temperature of 80° C., for three weeks. Thereafter, the substrate was removed from the opposite substrate, and it was checked whether or not the ink penetrated into a bonding interface of each bonded body.

Further, the others (ten bonded bodies) were immersed in the same ink as that described above for 100 days. Thereafter, the substrate was removed from the opposite substrate, and it was checked whether or not the ink penetrated into a bonding interface of each bonded body. The Result of the check was evaluated according to criteria described below.

Evaluation Criteria for Chemical Resistance

A: Ink did not penetrate into the bonded body at all.

B: Ink penetrated into the corner portions of the bonded body slightly.

C: Ink penetrated along the edge portions of the bonded body.

D: Ink penetrated into the inside of the bonded body.

2.4 Evaluation of Crystallinity Degree

In each of the bonded bodies obtained in the Examples 1 to 23 and the Comparative Examples 1 to 34, crystallinity degree of the Si-skeleton included in the bonding film thereof was measured. The obtained crystallinity degree was evaluated according to criteria described below.

Evaluation Criteria for Crystallinity Degree

A: The crystallinity degree was 30% or less.

B: The crystallinity degree was 30% or more, but lower than 45%.

C: The crystallinity degree was 45% or more, but lower than 55%.

D: The crystallinity degree was 55% or more.

2.5 Evaluation of Infrared Adsorption (FT-IR)

In each of the bonded bodies obtained in the Examples 1 to 23 and the Comparative Examples 1 to 34, the bonding film of the bonded body was subjected to a infrared adsorption method to obtain an infrared adsorption spectrum having peaks. The following items (1) and (2) were calculated by using the infrared adsorption spectrum.

The item (1) is a relative intensity of a peak derived from Si—H bonds with respect to a peak derived from siloxane (Si—O) bonds. The item (2) is a relative intensity of a peak derived from methyl groups (CH₃ bonds) with respect to the peak derived from the siloxane bonds.

2.6 Evaluation of Refractive Index

In each of the bonded bodies obtained in the Examples 1 to 23 and the Comparative Examples 1 to 34, a refractive index of the bonding film of the bonded body was measured.

2.7 Evaluation of Light Transmission Rate

In each of the bonded bodies obtained in the Examples 1 to 23 and the Comparative Examples 1 to 34, a light transmission rate of the bonded body which can be subjected to a light transmission rate measurement apparatus was measured. The obtained light transmission rate was evaluated according to criteria described below.

Evaluation Criteria for Light Transmission Rate

A: The light transmission rate was 95% or more.

B: The light transmission rate was 90% or more, but lower than 95%.

C: The light transmission rate was 85% or more, but lower than 90%.

D: The light transmission rate was lower than 85%.

2.8 Evaluation of Shape Change

Shape changes of the substrate and the opposite substrate were checked for each of the bonded bodies obtained in the Examples 16 to 23 and the Comparative Examples 16 to 20 and 24 to 26 before and after the bonded body was manufactured.

Specifically, warp amounts of the substrate and the opposite substrate were measured before and after the bonded body was manufactured, a change between the warp amounts was evaluated according to criteria described below.

Evaluation Criteria for Change between Warp Amounts

A: The warp amounts of the substrate and the opposite substrate were not changed hardly before and after the bonded body was manufactured.

B: The warp amounts of the substrate and the opposite substrate were changed slightly before and after the bonded body was manufactured.

C: The warp amounts of the substrate and the opposite substrate were changed rather significantly before and after the bonded body was manufactured.

D: The warp amounts of the substrate and the opposite substrate were changed significantly before and after the bonded body was manufactured.

Evaluation results of the above items 2.1 to 2.8 are shown in Tables 1 and 2.

TABLE 1

| | Conditions of manufacturing bonded body | | | | | | | |
|---|---|---|---|---|---|---|---|---|
| | Bonding film | | | | | | | |
| | | | | Output density | | Constituent | | |
| | Constituent | | | of high- | Postions of | material of | | |
| | material of | | | frequency | forming | opposite | Irradiation of | Heating |
| | substrate | Embodiment | Composition | voltage (W/cm²) | bonding film | substrate | ultraviolet ray | temperature |
| Ex. 1 | Silicon | Plasma | Octamethyl- | 25 (100 W) | Both | Glass | Before | 80° C. |
| Ex. 2 | Silicon | polymerization | trisiloxane | | substrate | Glass | laminating | 85° C. |
| Ex. 3 | Silicon | film | | | and opposite | Silicon | substrate and | 80° C. |
| Ex. 4 | Silicon | | | | substrate | Stainless | opposite | 80° C. |
| | | | | | | steel | substrate | |
| Ex. 5 | Silicon | | | | | Alminum | | 80° C. |
| Ex. 6 | Silicon | | | | | PET | | 80° C. |
| Ex. 7 | Silicon | | | | | PI | | 80° C. |
| Ex. 8 | Glass | | | | | Glass | | 80° C. |
| Ex. 9 | Glass | | | | | Stainless | | 80° C. |
| | | | | | | steel | | |
| Ex. 10 | Stainless | | | | | PET | | 80° C. |
| | steel | | | | | | | |
| Ex. 11 | Stainless | | | | | PI | | 80° C. |
| | steel | | | | | | | |
| Ex. 12 | Stainless | | | | | Alminum | | 80° C. |
| | steel | | | | | | | |
| Ex. 13 | Silicon | | | | | Glass | After | 80° C. |
| | | | | | | | laminating | |
| | | | | | | | substrate and | |
| | | | | | | | opposite | |
| | | | | | | | substrate | |
| Ex. 14 | Silicon | | | 37.5 (150 W) | | Glass | Before | 80° C. |
| Ex. 15 | Silicon | | | 50 (200 W) | Only | Glass | laminating | 80° C. |
| | | | | | substrate | | substrate and | |
| | | | | | | | opposite | |
| | | | | | | | substrate | |
| Comp. Ex. 1 | Silicon | Plasma | Octamethyl- | | | Glass | Before | 80° C. |
| Comp. Ex. 2 | Silicon | polymerization | trisiloxane | | | Glass | laminating | 85° C. |
| Comp. Ex. 3 | Silicon | film | | | | Silicon | substrate and | 80° C. |
| Comp. Ex. 4 | Silicon | | | | | Stainless | opposite | 80° C. |
| | | | | | | steel | substrate | |
| Comp. Ex. 5 | Silicon | | | | | Alminum | | 80° C. |
| Comp. Ex. 6 | Silicon | | | | | PET | | 80° C. |
| Comp. Ex. 7 | Silicon | | | | | PI | | 80° C. |
| Comp. Ex. 8 | Glass | | | | | Glass | | 80° C. |
| Comp. Ex. 9 | Glass | | | | | Stainless | | 80° C. |
| | | | | | | steel | | |
| Comp. Ex. 10 | Stainless | | | | | PET | | 80° C. |
| | steel | | | | | | | |
| Comp. Ex. 11 | Stainless | | | | | PI | | 80° C. |
| | steel | | | | | | | |
| Comp. Ex. 12 | Stainless | | | | | Alminum | | 80° C. |
| | steel | | | | | | | |
| Comp. Ex. 13 | Silicon | | | | | Glass | After | 80° C. |
| | | | | | | | laminating | |
| | | | | | | | substrate and | |
| | | | | | | | opposite | |
| | | | | | | | substrate | |
| Comp. Ex. 14 | Silicon | | | 37.5 (150 W) | | Glass | Before | 80° C. |
| Comp. Ex. 15 | Silicon | | | 50 (200 W) | | Glass | laminating | 80° C. |
| | | | | | | | substrate and | |
| | | | | | | | opposite | |
| | | | | | | | substrate | |
| Comp. Ex. 21 | Silicon | Adhesive | Epoxy-based | — | — | Glass | — | — |
| Comp. Ex. 22 | Silicon | | adhesive | | | Silicon | | |
| Comp. Ex. 23 | Silicon | | | | | Stainless | | |
| | | | | | | steel | | |
| Comp. Ex. 27 | Silicon | Coating film | Polyorganosiloxane- | — | Both | Glass | Before | 80° C. |
| Comp. Ex. 28 | Silicon | | based material | | substrate | Stainless | laminating | 80° C. |
| | | | | | and opposite | steel | substrate and | |
| Comp. Ex. 29 | Silicon | | | | substrate | PET | opposite | 80° C. |
| Comp. Ex. 30 | Glass | | | | | Glass | substrate | 80° C. |
| Comp. Ex. 31 | Stainless | | | | | Glass | | 80° C. |
| | steel | | | | | | | |
| Comp. Ex. 32 | Stainless | | | | | Stainless | | 80° C. |
| | steel | | | | | steel | | |
| Comp. Ex. 33 | Stainless | | | | | PET | | 80° C. |
| | steel | | | | | | | |
| Comp. Ex. 34 | Silicon | Vapor- | Polysilozane | — | | Glass | | 80° C. |
| | | deposited film | | | | | | |

| | Evaluation results | | | | | | | | | |
|---|---|---|---|---|---|---|---|---|---|---|
| | Bonding strength | | | | | | | | | |
| | | After | | | | | | | | |
| | Just | performing | | Chemical resistance | | Crystal- | | | | Light |
| | after | temperature | Dimensional | After | After | linity | Si—H/ | CH₂/ | Refractive | transmission |
| | bonding | cycle | accuracy | 3 weeks | 100 days | degree | Si—O—Si | Si—O—Si | index | rate |
| Ex. 1 | B | B | A | A | A | A | 0.02 | 0.22 | 1.44 | — |
| Ex. 2 | B | B | A | A | A | A | 0.02 | 0.22 | 1.44 | — |
| Ex. 3 | B | B | A | A | A | A | 0.02 | 0.22 | 1.44 | — |
| Ex. 4 | B | B | A | A | A | A | 0.02 | 0.22 | 1.44 | — |
| Ex. 5 | B | B | A | A | A | A | 0.02 | 0.22 | 1.44 | — |
| Ex. 6 | A | A | A | A | B | A | 0.02 | 0.22 | 1.44 | — |
| Ex. 7 | A | A | A | A | B | A | 0.02 | 0.22 | 1.44 | — |
| Ex. 8 | B | B | A | A | A | A | 0.02 | 0.22 | 1.44 | A |
| Ex. 9 | B | B | A | A | A | A | 0.02 | 0.22 | 1.44 | — |
| Ex. 10 | A | A | A | A | B | A | 0.02 | 0.22 | 1.44 | — |
| Ex. 11 | A | A | A | A | B | A | 0.02 | 0.22 | 1.44 | — |
| Ex. 12 | B | B | A | A | A | A | 0.02 | 0.22 | 1.44 | — |
| Ex. 13 | B | B | A | A | A | A | 0.02 | 0.22 | 1.44 | — |
| Ex. 14 | B | B | A | A | B | A | 0.02 | 0.20 | 1.45 | — |
| Ex. 15 | B | C | A | A | C | B | 0.03 | 0.17 | 1.49 | — |
| Comp. Ex. 1 | B | C | A | A | C | A | 0.02 | 0.22 | 1.44 | — |
| Comp. Ex. 2 | B | C | A | A | C | A | 0.02 | 0.22 | 1.44 | — |
| Comp. Ex. 3 | B | C | A | A | C | A | 0.02 | 0.22 | 1.44 | — |
| Comp. Ex. 4 | B | C | A | A | C | A | 0.02 | 0.22 | 1.44 | — |
| Comp. Ex. 5 | B | C | A | A | C | A | 0.02 | 0.22 | 1.44 | — |
| Comp. Ex. 6 | A | B | A | A | D | A | 0.02 | 0.22 | 1.44 | — |
| Comp. Ex. 7 | A | B | A | A | D | A | 0.02 | 0.22 | 1.44 | — |
| Comp. Ex. 8 | B | C | A | A | C | A | 0.02 | 0.22 | 1.44 | A |
| Comp. Ex. 9 | B | C | A | A | C | A | 0.02 | 0.22 | 1.44 | — |
| Comp. Ex. 10 | A | B | A | A | D | A | 0.02 | 0.22 | 1.44 | — |
| Comp. Ex. 11 | A | B | A | A | D | A | 0.02 | 0.22 | 1.44 | — |
| Comp. Ex. 12 | B | C | A | A | C | A | 0.02 | 0.22 | 1.44 | — |
| Comp. Ex. 13 | B | C | A | A | C | A | 0.02 | 0.22 | 1.44 | — |
| Comp. Ex. 14 | B | C | A | A | C | A | 0.02 | 0.20 | 1.45 | — |
| Comp. Ex. 15 | B | D | A | A | D | B | 0.03 | 0.17 | 1.49 | — |
| Comp. Ex. 21 | A | D | D | C | D | — | — | — | — | — |
| Comp. Ex. 22 | A | D | D | C | D | — | — | — | — | — |
| Comp. Ex. 23 | A | D | D | C | D | — | — | — | — | — |
| Comp. Ex. 27 | B | D | D | B | C | C | 0 | 0.49 | 1.56 | — |
| Comp. Ex. 28 | B | D | D | B | C | C | 0 | 0.49 | 1.56 | |
| Comp. Ex. 29 | B | D | D | B | D | C | 0 | 0.49 | 1.56 | — |
| Comp. Ex. 30 | B | D | D | B | C | C | 0 | 0.49 | 1.56 | D |
| Comp. Ex. 31 | B | D | D | B | C | C | 0 | 0.49 | 1.56 | — |
| Comp. Ex. 32 | B | D | D | B | C | C | 0 | 0.49 | 1.56 | — |
| Comp. Ex. 33 | B | D | D | B | D | C | 0 | 0.49 | 1.56 | — |
| Comp. Ex. 34 | C | D | A | C | D | C | 0 | — | — | — |

 PET: Polyethylene terephthalate
PI: Polymide

TABLE 2

| | Conditions of manufacturing bonded body | | | | | | | | |
|---|---|---|---|---|---|---|---|---|---|
| | | Bonding film | | | | | | | |
| | | | | Output density | | | | | |
| | | | | of high | | | Constituent | Irradiation | |
| | Constituent | | | frequency | | Positions of | material of | of | |
| | material of | | | voltage | Bonding | forming | opposite | ultraviolet | Heating |
| | substrate | Embodiment | Composition | (W/cm²) | region | bonding film | substrate | ray | temperature |
| Ex. 16 | Silicon | Plasma | Octamethyl- | 25 (100 W) | A part of | Both | Glass | Before | 80° C. |
| Ex. 17 | Silicon | polymerization | trisiloxane | | bonding | substrate | Glass | laminating | 25° C. |
| Ex. 18 | Silicon | film | | | surface | and opposite | Silicon | substrate | 80° C. |
| Ex. 19 | Silicon | | | | | substrate | PET | and | 80° C. |
| Ex. 20 | Silicon | | | | | | PI | opposite | 80° C. |
| Ex. 21 | Glass | | | | | | Glass | substrate | 80° C. |
| Ex. 22 | Stainless | | | | | | PET | | 80° C. |
| | steel | | | | | | | | |
| Ex. 23 | Stainless | | | | | | PI | | 80° C. |
| | steel | | | | | | | | |
| Comp. Ex. 16 | Silicon | Plasma | Octamethyl- | 25 (100 W) | A part of | Only | Stainless | Before | 80° C. |
| | | polymerization | trisiloxane | | bonding | substrate | steel | laminating | |
| Comp. Ex. 17 | Silicon | film | | | surface | | Stainless | substrate and | 25° C. |
| | | | | | | | steel | opposite | |
| Comp. Ex. 18 | Silicon | | | | | | Aluminum | substrate | 80° C. |
| Comp. Ex. 19 | Glass | | | | | | Stainless | | 80° C. |
| | | | | | | | steel | | |
| Comp. Ex. 20 | Stainless | | | | | | Aluminum | | 80° C. |
| | steel | | | | | | | | |
| Comp. Ex. 24 | Silicon | Adhesive | Epoxy-based | — | A part of | — | Glass | — | — |
| Comp. Ex. 25 | Silicon | | adhesive | | bonding | | Silicon | | |
| Comp. Ex. 26 | Silicon | | | | surface | | Stainless steel | | |

| | Evaluation results | | | | | | | | |
|---|---|---|---|---|---|---|---|---|---|
| | | Chemical resistance | | Warp | | | | | Light |
| | Dimensional | After 3 | After | amounts | Crystallinity | Si—H/ | CH₂/ | Refractive | transmission |
| | accuracy | weeks | 100 days | change | degree | Si—O—Si | Si—O—Si | index | rate |
| Ex. 16 | A | A | A | A | A | 0.02 | 0.22 | 1.44 | — |
| Ex. 17 | A | A | A | A | A | 0.02 | 0.22 | 1.44 | — |
| Ex. 18 | A | A | A | A | A | 0.02 | 0.22 | 1.44 | — |
| Ex. 19 | A | A | B | B | A | 0.02 | 0.22 | 1.44 | — |
| Ex. 20 | A | A | B | B | A | 0.02 | 0.22 | 1.44 | — |
| Ex. 21 | A | A | A | A | A | 0.02 | 0.22 | 1.44 | A |
| Ex. 22 | A | A | B | B | A | 0.02 | 0.22 | 1.44 | — |
| Ex. 23 | A | A | B | B | A | 0.02 | 0.22 | 1.44 | — |
| Comp. Ex. 16 | A | A | C | B | A | 0.02 | 0.22 | 1.44 | — |
| Comp. Ex. 17 | A | A | C | A | A | 0.02 | 0.22 | 1.44 | — |
| Comp. Ex. 18 | A | A | C | B | A | 0.02 | 0.22 | 1.44 | — |
| Comp. Ex. 19 | A | A | C | B | A | 0.02 | 0.22 | 1.44 | — |
| Comp. Ex. 20 | A | A | C | A | A | 0.02 | 0.32 | 1.44 | — |
| Comp. Ex. 24 | D | C | D | A | — | — | — | — | — |
| Comp. Ex. 25 | D | C | D | A | — | — | — | — | — |
| Comp. Ex. 26 | D | C | D | B | — | — | — | — | — |

 PET: Polyethylene terephthalate
PI: Polyimide

As is apparent in Tables 1 and 2, the bonded bodies obtained in the Examples 1 to 23 exhibited excellent characteristics in all the items of the bonding strength, the dimensional accuracy, the chemical resistance, and the light transmission rate. Furthermore, in each of the bonded bodies obtained in the Examples 1 to 23, it was confirmed that the Si—H bonds were included in the bonding film based on the analysis of the infrared adsorption spectrum. Furthermore, it was confirmed that the crystallinity degree of the bonding film in which the Si—H bonds were included was low.

As descried above, it was conceived that the reason why the bonded bodies obtained in the Examples 1 to 23 exhibited the superior characteristics was caused by the low crystallinity degree of the Si-skeleton (the constituent atoms of the bonding film are more bonded to each other) with the inclusion of the Si—H bonds in the bonding film which was formed by the plasma polymerization method.

Furthermore, each of the bonded bodies obtained in the Examples 1 to 23 obtained by bonding the bonding films together exhibited high bonding property in the bonding interface thereof. Therefore, the bonding strength and the chemical resistance between the bonding films of each of the bonded bodies obtained in the Examples 1 to 23 were superior to those of each of the bonded bodies obtained in the Comparative Examples 1 to 15 by bonding the bonding film and the opposite substrate.

Furthermore, in each of the bonded bodies obtained in the Examples 1 to 23, it was confirmed that the refractive index was changed by changing the output density of the high-frequency voltage during the formation of the bonding films.

On the other hand, the bonded bodies obtained in the Comparative Examples 1 to 34 did not have enough chemical resistance, bonding strength and light transmission rate.

### INDUSTRIAL APPLICABILITY

A base member including a bonding film according to the present invention includes a first object comprised of a first substrate and a first bonding film formed on the first substrate, and a second object comprised of a second substrate and a second bonding film formed on the second substrate.

The first and second bonding films contain a Si-skeleton constituted of constituent atoms containing silicon atoms and elimination groups bonded to the silicon atoms of the Si-skeleton. The Si-skeleton includes siloxane (Si—O) bonds. The constituent atoms are bonded to each other.

When an energy is applied to at least a part region of the surface of each of the first and second bonding films, the elimination groups existing in the vicinity of the surface within the region are removed from the silicon atoms of the Si-skeleton so that each region develops a bonding property with respect to the other film to thereby bond the first and second objects together through the first and second bonding films.

Accordingly, it is possible to obtain a bonded body formed by firmly bonding two base members (objects) together with high dimensional accuracy and efficiently bonding them together at a low temperature and therefore being capable of providing high reliability.

Further, since the first and second bonding films include the Si-skeleton including the siloxane bonds, of which constituent atoms are bonded to each other, it becomes difficult for the first and second bonding films to deform, thereby providing a firm bonding film. Therefore, high bonding strength, chemical resistance, and dimensional accuracy are obtained in the first and second bonding films in itself.

Also in the bonded body in which the objects are bonded to each other, high bonding strength, chemical resistance, and dimensional accuracy are obtained. Accordingly, the bonded body according to the present invention has industrial applicability.

What is claimed is:

1. A bonded body comprising:
a first object comprised of a first substrate and a first bonding film formed on the first substrate, the first bonding film containing a Si-skeleton constituted of constituent atoms containing silicon atoms and elimination groups bonded to the silicon atoms of the Si-skeleton, the Si-skeleton including siloxane (Si—O) bonds, wherein the constituent atoms are bonded to each other, and the first bonding film having a surface; and
a second object comprised of a second substrate and a second bonding film formed on the second substrate, and the second bonding film having a surface, wherein the second bonding film contains the Si-skeleton and the elimination groups which are the same as those contained in the first bonding film;
wherein when an energy is applied to at least a part region of the surface of each of the first and second bonding films, the elimination groups existing in the vicinity of the surface within the region are removed from the silicon atoms of the Si-skeleton so that each region develops a bonding property with respect to the other film to thereby bond the first and second objects together through the first and second bonding films.

2. The bonded body as claimed in claim 1, wherein the constituent atoms have hydrogen atoms and oxygen atoms, and a sum of a content of the silicon atoms and a content of the oxygen atoms in the constituent atoms other than the hydrogen atoms is in the range of 10 to 90 atom % in at least one of the first and second bonding films.

3. The bonded body as claimed in claim 1, wherein the constituent atoms have oxygen atoms, and an abundance ratio of the silicon atoms and the oxygen atoms is in the range of 3:7 to 7:3 in the bonding film in at least one of the first and second bonding films.

4. The bonded body as claimed in claim 1, wherein a crystallinity degree of the Si-skeleton is equal to or lower than 45%.

5. The bonded body as claimed in claim 1, wherein the Si-skeleton of at least one of the first and second bonding films contains Si—H bonds.

6. The bonded body as claimed in claim 5, wherein in the case where the at least one of the first and second bonding films containing the Si-skeleton containing the Si—H bonds is subjected to an infrared absorption measurement by an infrared adsorption measurement apparatus to obtain an infrared absorption spectrum having peaks, when an intensity of the peak derived from the siloxane bond in the infrared absorption spectrum is defined as “1”, an intensity of the peak derived from the Si—H bond in the infrared absorption spectrum is in the range of 0.001 to 0.2.

7. The bonded body as claimed in claim 1, wherein the elimination groups are constituted of at least one selected from the group consisting of a hydrogen atom, a boron atom, a carbon atom, a nitrogen atom, an oxygen atom, a phosphorus atom, a sulfur atom, a halogen-based atom and an atom group which is arranged so that these atoms are bonded to the Si-skeleton.

8. The bonded body as claimed in claim 7, wherein the elimination groups are an alkyl group containing a methyl group.

9. The bonded body as claimed in claim 8, wherein in the case where the at least one of the first and second bonding films containing the methyl groups as the elimination groups is subjected to an infrared absorption measurement by an infrared absorption measurement apparatus to obtain an infrared absorption spectrum having peaks, when an intensity of the peak derived from the siloxane bond in the infrared absorption spectrum is defined as “1”, an intensity of the peak derived from the methyl group in the infrared absorption spectrum is in the range of 0.05 to 0.45.

10. The bonded body as claimed in claim 1, wherein active hands are generated on the silicon atoms of the Si-skeleton contained in the at least one of the first and second bonding films, after the elimination groups existing at least in the vicinity thereof are removed from the silicon atoms of the Si-skeleton.

11. The bonded body as claimed in claim 10, wherein the active hands are dangling bonds or hydroxyl groups.

12. The bonded body as claimed in claim 1, wherein the at least one of the first and second bonding films is formed by using a plasma polymerization method.

13. The bonded body as claimed in claim 12, wherein the at least one of the first and second bonding films is constituted of polyorganosiloxane as a main component thereof.

14. The bonded body as claimed in claim 13, wherein the polyorganosiloxane is constituted of a polymer of octamethyltrisiloxane as a main component thereof.

15. The bonded body as claimed in claim 12, wherein the plasma polymerization method includes a high frequency applying process and a plasma generation process, and a power density of the high frequency during the high frequency applying process and the plasma generation process is in the range of 0.01 to 100 W/cm².

16. The bonded body as claimed in claim 1, wherein an average thickness of the at least one of the first and second bonding films is in the range of 1 to 1000 nm.

17. The bonded body as claimed in claim 1, wherein the at least one of the first and second bonding films is a solid-state film having no fluidity.

18. The bonded body as claimed in claim 1, wherein a refractive index of the at least one of the first and second bonding films is in the range of 1.35 to 1.6.

19. The bonded body as claimed in claim 1, wherein at least one of the first and second substrates has a plate shape.

20. The bonded body as claimed in claim 1, wherein at least one of a portion of the first substrate on which the first bonding film is formed and a portion of the second substrate on which the second bonding film is formed are constituted of a silicon material, a metal material or a glass material as a main component thereof.

21. The bonded body as claimed in claim 1, wherein the first substrates has a surface on which the first bonding film is provided, the second substrates has a surface on which the second bonding film is provided, and at least one of the surfaces of the first and second substrates has been, in advance, subjected to a surface treatment for improving bonding strength to at least one between the first substrate and the first bonding film and between the second substrate and the second bonding film.

22. The bonded body as claimed in claim 21, wherein the surface treatment is a plasma treatment.

23. The bonded body as claimed in claim 1 further comprising an intermediate layer provided in at least one between the first substrate and the first bonding film and between the second substrate and the second bonding film.

24. The bonded body as claimed in claim 23, wherein the intermediate layer is constituted of an oxide-based material as a main component thereof.

25. A bonding method of forming a bonded body, the bonding method comprising:
providing a first object comprised of a first substrate and a first bonding film formed on the first substrate, the first bonding film containing a Si-skeleton constituted of constituent atoms containing silicon atoms and elimination groups bonded to the silicon atoms of the Si-skeleton, the Si-skeleton including siloxane (Si—O) bonds, wherein the constituent atoms are bonded to each other, and the first bonding film having a surface;
providing a second object comprised of a second substrate and a second bonding film formed on the second substrate, and the second bonding film having a surface, wherein the second bonding film contains the Si-skeleton and the elimination groups which are the same as those contained in the first bonding film;
applying an energy to at least a part region of the surface of each of the first and second bonding films; and
making the at least the part regions of the surfaces of the first and second bonding films close contact with each other, so that the first object and the second object are bonded together through the first and second bonding films, to thereby obtain the bonded body.

26. A bonding method of forming a bonded body, the bonding method comprising:
providing a first object comprised of a first substrate and a first bonding film formed on the first substrate, the first bonding film containing a Si-skeleton constituted of constituent atoms containing silicon atoms and elimination groups bonded to the silicon atoms of the Si-skeleton, the Si-skeleton including siloxane (Si—O) bonds, wherein the constituent atoms are bonded to each other, and the first bonding film having a surface;
providing a second object comprised of a second substrate and a second bonding film formed on the second substrate, and the second bonding film having a surface, wherein the second bonding film contains the Si-skeleton and the elimination groups which are the same as those contained in the first bonding film;
making the surfaces of the first and second bonding films close contact with each other to thereby obtain a pre-contacted body; and
applying an energy to at least a part region of the surface of each of the first and second bonding films in the pre-contacted body, so that the first object and the second object are bonded together through the first and second bonding films, to thereby obtain the bonded body.

27. The bonding method as claimed in claim 25, wherein the applying the energy is carried out by at least one method selected from the group comprising a method in which an energy beam is irradiated on the first and second bonding films, a method in which the first and second bonding films are heated and a method in which a compressive force is applied to the first and second bonding films.

28. The bonding method as claimed in claim 27, wherein the energy beam is an ultraviolet ray having a wavelength of 150 to 300 nm.

29. The bonding method as claimed in claim 27, wherein a temperature of the heating is in the range of 25 to 100° C.

30. The bonding method as claimed in claim 27, wherein the compressive force is in the range of 0.2 to 10 MPa.

31. The bonding method as claimed in claim 25, wherein the applying the energy is carried out in an atmosphere.

32. The bonding method as claimed in claim 25 further comprising subjecting the bonded body to a treatment for improving bonding strength between the first and second bonding films.

33. The bonding method as claimed in claim 32, wherein the subjecting the bonded body to the treatment is carried out by at least one method selected from the group comprising a method in which an energy beam is irradiated on the bonded body, a method in which the bonded body is heated and a method in which a compressive force is applied to the bonded body.
